(19) United States
(12) Patent Application Publication
(10) Pub. No.: US 2017/0318613 A1
(43) Pub. Date: Nov. 2, 2017

(54) BASE STATION DEVICE, POSITION MANAGEMENT DEVICE, TERMINAL DEVICE, AND CONTROL METHOD

(71) Applicant: SHARP KABUSHIKI KAISHA, Sakai City, Osaka (JP)

(72) Inventors: Yoko KUGE, Sakai City (JP); Masafumi ARAMOTO, Sakai City (JP)

(73) Assignee: SHARP KABUSHIKI KAISHA, Sakai City, Osaka (JP)

(21) Appl. No.: 15/525,992

(22) PCT Filed: Nov. 10, 2015
(86) PCT No.: PCT/JP2015/081550

§ 371 Date: May 11, 2017

(30) Foreign Application Priority Data
Nov. 11, 2014 (JP) 2014-228504

(51) Int. Cl. H04W 76/02; H04L 29/12; H04W 60/06; H04W 60/04; H04W 48/10

(52) U.S. Cl. CPC H04W 76/021; H04W 60/06; H04W 60/04; H04L 61/30; H04L 61/3075; H04W 48/10

(57) ABSTRACT

An access network has a position management device function, the loss of connectivity to a core network by a base station is detected, and a state transition process, led by the base station, for transitioning to an Isolated E-UTRAN state is initiated on the basis of the detection. In the state transition process, by performing a reattach procedure from a terminal device, a switch to base station loop-back communication can be made. It is possible thereby to provide a communication control method by which communication between terminals present within the communication coverage of a base station which has lost connectivity to a core network is switched to base station loop-back communication.

### TECHNICAL FIELD

The present invention relates to a base station device, a position management device, a terminal device, and a control method.

### BACKGROUND ART

The 3rd Generation Partnership Project (3GPP), which undertakes activities for standardizing recent mobile communication systems, is in the process of creating specifications for the Evolved Packet System (EPS), described in NPL 1, in which an all-IP architecture is implemented. The EPS is a mobile communication system through which a mobile carrier or the like offers mobile telephone services, and is constituted to include a core network called the Evolved Packet Core (EPC), or an access network or the like according to the wireless communication standard which is referred to as the Long Term Evolution (LTE).

As part of the ongoing standardization of the EPS by the 3GPP, an Isolated E-UTRAN Operation for Public Safety (IOPS) is currently under study, where it is intended to realize base station loop-back communication in an access network made up by a base station device that has lost a connection to a core network (backhaul) due to a disaster or the like. By so doing, communication between nearby terminals can be provided to terminals which exist within the communication coverage of a base station making up part of a given access network, even when the connection between the base station and the core network is severed, or limitations on the connection are necessary.

### CITATION LIST

### Non Patent Literature

NPL 1: 3GPP TS23.401 Technical Specification Group Services and System Aspects, General Packet Radio Service (GPRS) enhancements for Evolved Universal Terrestrial Radio Access Network (E-UTRAN) access (Release 12)

NPL 2: 3GPP TS 22.346 Technical Specification Group Services and System Aspects; Isolated E-UTRAN Operation for Public Safety; Stage 1 (Release 13)

### SUMMARY OF INVENTION

### Technical Problem

In IOPS, a feature whereby a base station loop-back data transfer service according to IOPS is initiated through a state transition from a normal state in which the base station is connected normally to the core network, to a state in which the base station has lost the connection to the core network, or a state in which some sort of limitation is imposed on the connection is currently under study.

However, currently there is no obvious means by which to initiate the base station loop-back data transfer service in association with such a state transition of an access network with respect to a core network. Further, there is no obvious specific means for implementing a base station loop-back data transfer method.

With the foregoing in view, it is an object of the present invention to provide suitable means for switching communication between terminal devices present within the communication coverage of the same base station to loop-back communication via the base station or a gateway in association with a state transition of the connection state of the base station to a core network; and suitable means for providing communication between terminals using a base station that has lost connection to the core network.

### Solution to Problem

A base station device according to an aspect of the present invention is configured to: establish a first PDN connection to a first terminal device; establish a second PDN connection to a second terminal device, the first PDN connection and the second PDN connection being PDN connections established using an APN for which communication based on an Isolated E-UTRAN function has been permitted, and the Isolated E-UTRAN function being a user data transfer function by a base station device in a first state in which the base station device lacks connectivity to a core network and/or a second state in which connectivity of the base station device to the core network is limited; use the first PDN connection to receive user data transmitted by the first terminal device; and use the second PDN connection to transmit the user data to the second terminal device.

A base station device according to an aspect of the present invention is configured to: acquire an access point name (APN) included in a control message of an attach procedure initiated by a first terminal device, the APN being an APN for which communication based on an Isolated E-UTRAN function has been permitted, and the Isolated E-UTRAN function being a user data transfer function by a gateway in a first state in which the base station device lacks connectivity to a core network and/or a second state in which connectivity of the base station device to the core network is limited; select, in response to the acquiring of the APN, a first gateway the use of which as a gateway for providing a PDN connection in the Isolated E-UTRAN function is permitted; and permit a first PDN connection to be established between the first gateway and the first terminal device.

The base station device according to an aspect of the present invention is further configured to: acquire, on the basis of the first terminal device being connected to the core network by using the APN for which communication based on an Isolated E-UTRAN function has been permitted, first permission information for permitting to communicate on the basis of the Isolated E-UTRAN function from a position management device or the first terminal device; the position management device being a device configured to perform position management of the first terminal device; and store the first PDN connection and the first permission information associated therewith.

The base station device according to an aspect of the present invention is further configured to: transmit a first announcement message to the first terminal device, the first announcement message being a message announcing a detach request and a need for an attachment; and acquire an APN by an attach procedure initiated by the first terminal device in response to the first announcement message.

The base station device according to an aspect of the present invention is in that the first announcement message is a layer 2 level message, and the first announcement message requests deletion of a terminal context stored by the first terminal device and indicating an attach state of the first terminal device.

The base station device according to an aspect of the present invention is further configured to: broadcast, to a radio area of the base station device, first tracking area identification information which is included in broadcast information, in order to receive a tracking area update request message from a first terminal device, in response to a transition to a first state and/or a second state, the first tracking area identification information being identification information that differs from second tracking area identification information which has been included in broadcast information transmitted prior to transition to the first state and/or the second state; and receive a tracking area update request message from the first terminal device.

A terminal device according to an aspect of the present invention is further configured to: establish a PDN connection using an access point name (APN) for which communication based on an Isolated E-UTRAN function has been permitted, the Isolated E-UTRAN function being a user data transfer function by a base station device or gateway in a first state in which the base station device lacks connectivity to a core network and/or a second state in which connectivity of the base station device to the core network is limited, and the PDN connection being a PDN connection for which communication based on an Isolated E-UTRAN function has been permitted; and use the PDN connection to transmit the user data to the base station device.

The terminal device according to an aspect of the present invention is further configured to transmit, on the basis of a PDN connection having been established by using an APN, by the terminal device, permission information for permitting to communicate on the basis of an Isolated E-UTRAN function to the base station device.

The terminal device according to an aspect of the present invention is further configured to: receive an announcement message from the base station device, the announcement message being a message announcing a detach request and a need for an attachment; and transmit, in response to the receiving of the announcement message, to the base station device, an attach request message to initiate an attach procedure.

The terminal device according to an aspect of the present invention where the announcement message is a layer 2 level message, is further configured to delete, in response to the receiving of the announcement message, from the terminal device, a terminal context indicating an attach state of the terminal device.

The terminal device according to an aspect of the present invention where the announcement message includes identification information that identifies an application; is further configured to release a radio resource that was allocated to a first application, in response to the receiving of the announcement message, and transmit, to the base station device, a response message to the announcement message.

The terminal device according to an aspect of the present invention is configured to: receive broadcast information broadcast by the base station device and/or a position management device, the broadcast information including first tracking area identification information, and the first tracking area identification information being identification information that differs from second tracking area identification information which has been included in broadcast information transmitted prior to transition to a first state and/or a second state; and transmit, in response to the receiving of the broadcast information, a tracking area update request message to the base station device.

A method of controlling a base station device according to an aspect of the present invention is a control method for a base station device, including: establishing a first PDN connection to a first terminal device; establishing a second PDN connection to a second terminal device, the first PDN connection and the second PDN connection being PDN connections established using an APN for which communication based on an Isolated E-UTRAN function has been permitted, and the Isolated E-UTRAN function being a user data transfer function employed by the base station device in a first state in which the base station device lacks connectivity to a core network and/or a second state in which connectivity of the base station device to the core network is limited; using the first PDN connection to receive user data transmitted by the first terminal device; and using the second PDN connection to transmit the user data to the second terminal device.

A method of controlling a base station device according to an aspect of the present invention includes: acquiring an access point name (APN) included in a control message of an attach procedure initiated by a first terminal device, the APN being an APN for which communication based on an Isolated E-UTRAN function has been permitted, and the Isolated E-UTRAN function being a user data transfer function by a gateway in a first state in which the base station device lacks connectivity to a core network and/or a second state in which connectivity of the base station device to the core network is limited; selecting, in response to the acquiring of the APN, a first gateway the use of which as a gateway for providing a PDN connection in the Isolated E-UTRAN function is permitted; and permitting a first PDN connection to be established between the first gateway and the first terminal device.

The method of controlling a base station device according to an aspect of the present invention includes: acquiring, on the basis of the first terminal device being connected to a core network by using an APN for which communication based on an Isolated E-UTRAN function has been permitted, first permission information for permitting to communicate on the basis of the Isolated E-UTRAN function from a position management device or the first terminal device, the position management device being a device configured to perform position management of the first terminal device; and storing a first PDN connection and the first permission information in association therewith.

The method of controlling a base station device according to an aspect of the present invention includes: transmitting a first announcement message to the first terminal device, the first announcement message being a message announcing a detach request and a need for an attachment; and acquiring an APN by an attach procedure initiated by the first terminal device in response to the first announcement message.

The method of controlling a base station device according to an aspect of the present invention where the first announcement message is a layer 2 level message, includes: requesting, by the first announcement message, deletion of a terminal context stored by the first terminal device and indicating an attach state of the first terminal device.

The method of controlling a base station device according to an aspect of the present invention includes: broadcasting, to a radio area of the base station device, first tracking area identification information which is included in broadcast information, in order to receive a tracking area update request message from the first terminal device, in response to a transition to a first state and/or a second state, the first tracking area identification information being identification information that differs from second tracking area identification information which has been included in the broadcast information transmitted prior to transition to the first state and/or the second state; and receiving a tracking area update request message from the first terminal device.

A method of controlling a terminal device according to an aspect of the present invention includes: establishing a PDN connection using an access point name (APN) for which communication based on an Isolated E-UTRAN function has been permitted, the Isolated E-UTRAN function being a user data transfer function employed by the base station device or gateway in a first state in which the base station device lacks connectivity to a core network and/or a second state in which connectivity of the base station device to the core network is limited, and the PDN connection being a PDN connection for which communication based on an Isolated E-UTRAN function has been permitted; and using the PDN connection to transmit the user data to the base station device.

The method of controlling a terminal device according to an aspect of the present invention includes transmitting, on the basis of a PDN connection having been established by using an APN, by the terminal device, to the base station device, permission information for permitting to communicate on the basis of an Isolated E-UTRAN function.

The method of controlling a terminal device according to an aspect of the present invention includes: receiving an announcement message from the base station device, the announcement message being a message announcing a detach request and a need for an attachment; and transmitting to the base station device an attach request message to initiate an attach procedure, in response to the receiving of the announcement message.

The method of controlling a terminal device according to an aspect of the present invention where the announcement message is a layer 2 level message, includes deleting from the terminal device a terminal context indicating an attach state of the terminal device, in response to the receiving of the announcement message.

The method of controlling a terminal device according to an aspect of the present invention where the announcement message includes identification information that identifies an application, includes: releasing a radio resource that was allocated to a first application, in response to the receiving of the announcement message; and transmitting to the base station device a response message to the announcement message.

The method of controlling a terminal device according to an aspect of the present invention includes receiving broadcast information broadcast by a base station device and/or a position management device, the broadcast information includes first tracking area identification information, and the first tracking area identification information is identification information that differs from second tracking area identification information which has been included in broadcast information transmitted prior to transition to the first state and/or the second state, and transmitting, in response to the receiving of the broadcast information, a tracking area update request message to the base station device.

### Advantageous Effects of Invention

According to the present invention, communication between terminal devices present within the communication coverage of a base station device that has lost a normal connection to a core network can be accomplished through communication via the base station device, rather than via the core network.

### BRIEF DESCRIPTION OF DRAWINGS

FIG. 1 is a diagram for illustrating an overview of a mobile communication system.

FIG. 2 is a diagram for illustrating the constitution of an IP mobile communication network and the like.

FIG. 3 is a diagram for illustrating the functional constitution of a UE.

FIG. 4 is a diagram for illustrating the functional constitution of an eNB.

FIG. 5 is a diagram for illustrating the functional constitution of a storage unit of an eNB.

FIG. 6 is a diagram for illustrating switching of communication.

FIG. 7 is a diagram for illustrating a communication switching method, and a first modification.

FIG. 8 is a diagram for illustrating a communication switching method, and a second modification.

FIG. 9 is a diagram for illustrating transfer of user data by a base station.

FIG. 10 is a diagram for illustrating a second embodiment of a communication switching method.

FIG. 11 is a diagram for illustrating a second embodiment and a first modification of a communication switching method.

FIG. 12 is a diagram for illustrating the second embodiment and a second modification of a communication switching method.

FIG. 13 is a diagram for illustrating a third embodiment of a communication switching method.

FIG. 14 is a diagram for illustrating the third embodiment and a first modification of a communication switching method.

FIG. 15 is a diagram for illustrating the third embodiment and a second modification of a communication switching method.

### DESCRIPTION OF EMBODIMENTS

Hereinafter, an embodiment for implementing the present invention will be described with reference to the drawings. Note that in the present embodiment, an embodiment of a mobile communication system when the present invention is applied is described by way of an example.

### 1. First Embodiment

Hereinafter, a wireless communication technology according to an embodiment of the present invention will be described in detail with reference to the drawings.

### 1.1. System Overview

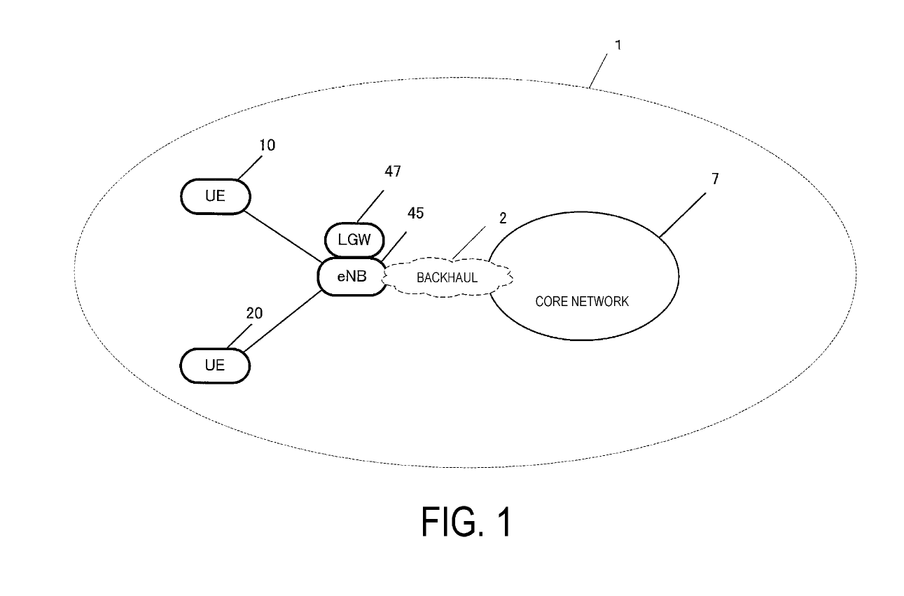

FIG. 1 is a diagram for illustrating an overview of a mobile communication system according to the present embodiment. As illustrated in the drawing, the mobile communication system 1 is constituted by a mobile terminal device UE 10, a mobile terminal device UE 20, a base station device eNB 45, a local gateway (LGW) 47, and a core network 7. It should be noted that, as illustrated in the drawing, the eNB 45 and the core network 7 in the present embodiment are connected by a backhaul 2.

In the present embodiment, a state of an LTE access network or a base station in which the backhaul 2 is maintaining normal connectivity is considered to be a normal state in which the LTE access network is considered to be an E-UTRAN.

A state in which, on the other hand, the backhaul 2 has completely lost connectivity, or a state of an LTE access network or a base station when it has become necessary to limit communication using the backhaul 2, is considered to be an Isolated E-UTRAN state, in which state the LTE access network is considered to be an Isolated E-UTRAN. The Isolated E-UTRAN state may be a communication state in which user data transmitted by a UE is delivered to other UEs by the base station as an anchor device.

Further, the state of an LTE access network or a base station when the backhaul 2 has completely lost connectivity is denoted as Isolated E-UTRAN state A, and the state of an LTE access network or a base station when it has become necessary to limit communication using the backhaul 2 is denoted as Isolated E-UTRAN state B.

Here, the limitation of communication using the backhaul 2 in the Isolated E-UTRAN state B may be, for example, a limitation whereby only control signals are permitted. Alternatively, the limitation of communication may be limitation of both control signals and user data on the basis of a user, an application, or the like.

In the present embodiment, the method employed in the present embodiment for switching communication between terminals from normal communication via a packet data network (PDN) to communication based on an Isolated E-UTRAN function in association with a state transition of an LTE access network or connectivity to the core network by a base station will be described.

It should be noted that in the present embodiment, communication based on an Isolated E-UTRAN function refers to a communication method that uses base stations included in an LTE access network which is in an Isolated E-UTRAN state (Isolated E-UTRAN state A and/or Isolated E-UTRAN state B), the communication relying on base station or gateway loop-back, without being routed via the core network.

Consequently, the Isolated E-UTRAN function is a base station and/or gateway function for transferring user data while the base station device is in the Isolated E-UTRAN state.

Alternatively, the Isolated E-UTRAN function may refer to a function for executing a process or procedure while a base station and/or a gateway and/or a terminal device and/or a position management device are/is in an Isolated E-UTRAN state, as described in the present embodiment.

Here, “core network” refers to an IP mobile communication network administrated by a mobile operator.

The core network 7 is connected to a PDN. A PDN refers to a packet data service network that provides communication services to the UE 10 and the UE 20, and may be constituted on a per-service basis. Communication terminals are connected to the PDN, and the UE 10 and the UE 20 can transmit and receive user data to and from communication terminals situated on the same PDN.

LGW 47 is a relay device combined with the eNB 45 that transfers user data without using the carrier's network. Also the LGW 47 might be a relay device configured to transfer user data independently from the eNB 45. The LGW 47 can also be utilized as a gateway providing a PDN connection, when a base station in the Isolated E-UTRAN state carries out communication based on the Isolated E-UTRAN function.

Next, a core network constitution example will be described. The core network is constituted by a home subscriber server (HSS), an authentication, authorization, accounting (AAA), a policy and charging rules function (PCRF), a packet data network gateway (PGW), an enhanced packet data gateway (ePDG), a serving gateway (SGW), and a Mobility Management Entity (MME). Such devices may be installed in respective fashion for every core network.

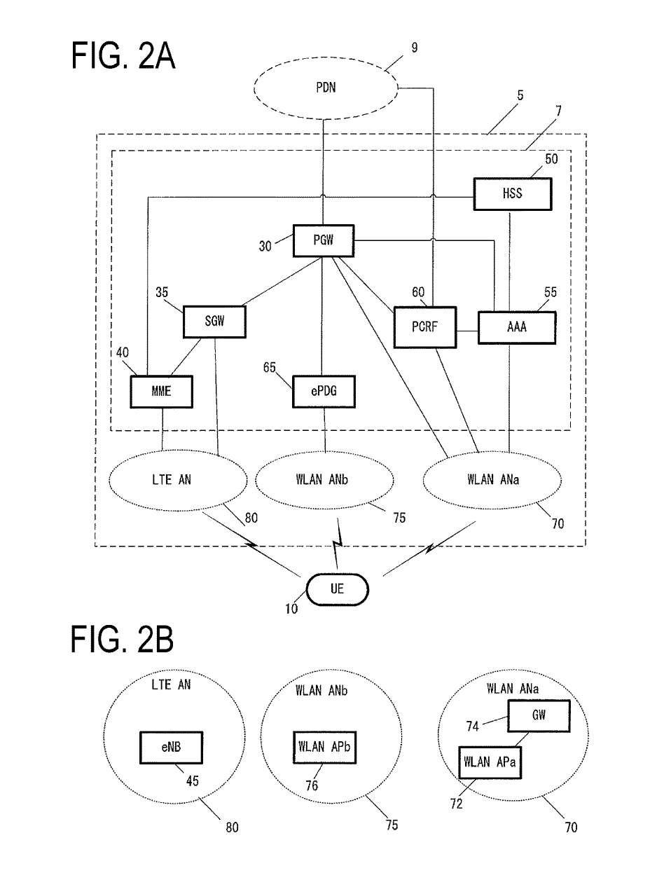

FIG. 2 illustrates a diagram for describing an IP mobile communication network. The present embodiment describes mainly an example in which the core network 7 is constituted by an HSS 50, an AAA 55, a PCRF 60, a PGW 30, and an ePDG 65, an SGW 35, and an MME 40, as illustrated in the drawing.

Additionally, the core network 7 can be connected to multiple access networks (an LTE AN 80, a WLAN ANb 75, and a WLAN ANa 70).

The radio access network may be constituted by connections to multiple different access networks, or by a connection to any one access network. Furthermore, the UE 10 and the UE 20 can wirelessly connect to the radio access network.

Furthermore, the WLAN access network b (WLAN ANb 75) that connects to the core network via the ePDG 65, and the WLAN access network a (WLAN ANa 75) that connects to the PGW 30, the PCRF 60, and the AAA 55, can be constituted as access networks capable of connecting by a WLAN access system.

It should be noted that each device has a constitution similar to conventional devices in a mobile communication system that uses the EPS, and therefore detailed descriptions will be omitted. Each device will be described briefly hereinafter.

The PGW 30 is a relay device which is connected to a PDN 9, the SGW 35, the ePDG 65, the WLAN ANa 70, the PCRF 60, and the AAA 55, and which transfers user data as a gateway device between the PDN 9 and the core network 7.

The SGW 35 is connected to the PGW 30, the MME 40, and the LTE AN 80, and a relay device which transfers user data as a gateway device between the core network 7 and the LTE AN 80.

The MME 40 is connected to the SGW 35, the LTE AN 80, and the HSS 50, and is an access control device that carries out location information management and access control for the UE 10 via the LTE AN 80. The core network 7 may include multiple position management devices. For example, an MME_C may be incorporated into the core network 7 as a different position management device from the MME 40. Like the MME 40, the MME_C may be connected to the SG 35, the LTE AN 80, and the HSS 50. By so doing, the MME_C and the MME 40 may transmit and receive contexts of the UE 10.

The HSS 50 is connected to the MME 40 and the AAA 55, and is a management node for managing subscriber information. The subscriber information of the HSS 50 is referenced, for example, during MME 40 access control.

The AAA 55 is connected to the PGW 30, the HSS 50, the PCRF 60, and the WLAN ANa 70, and carries out access control of the UE 10 which is connected via the WLAN ANa 70.

The PCRF 60 is connected to the PGW 30, the WLAN ANa 75, the AAA 55, and the PDN 9, and carries out QoS management for data delivery. QoS management of the communication path between the UE 10 and the PDN 9 is carried out, for example.

The ePDG 65 is connected to the PGW 30 and to the WLAN ANb 75, and delivers user data as a gateway device of the core network 7 and the WLAN ANb 75.

Meanwhile, as illustrated in FIG. 2(b), each radio access network includes a device to which the UE 10 is actually connected (such as a base station device or an access point device), and the like. Devices adapted to the radio access networks are possible devices for use in such connections.

In the present embodiment, the LTE AN 80 includes an eNB 45. The eNB 45 is a radio base station to which the UE 10 connects by an LTE access system, and the LTE AN 80 may include one or multiple radio base stations.

The WLAN ANa 70 includes a WLAN APa 72 and a gateway (GW) 74. The WLAN APa 72 is a radio base station to which the UE 10 connects by a WLAN access system trusted by the operator who operates the core network 7, and the WLAN ANa 70 may include one or multiple radio base stations. The GW 74 is a gateway device between the core network 7 and the WLAN ANa 70. The WLAN APa 72 and the GW 74 may be constituted by a single device.

Additionally, the WLAN ANb 75 includes a WLAN APb 76. The WLAN APb 76 is a radio base station to which the UE 10 connects by a WLAN access system when no trusted relationship has been established with the operator who operates the core network 7, and the WLAN ANb 75 may include one or multiple radio base stations.

In this way, the WLAN ANb 75 is connected to the core network 7 via the ePDG 65, which is a device included in the core network 7 as a gateway. The ePDG 65 has a security function for ensuring security.

Note that in the present specification, the UE 10 and the UE 20 being connected to each radio access network refers to the UE 10 and the UE 20 being connected to a base station device, an access point, or the like included in each radio access network, and data, signals, and the like being transmitted and received also transfer via those base station devices, access points, or the like.

### 1.2. Device Constitution

Subsequently, the constitution of each device will be described briefly using the drawings.

### 1.2.1. UE Constitution Diagram

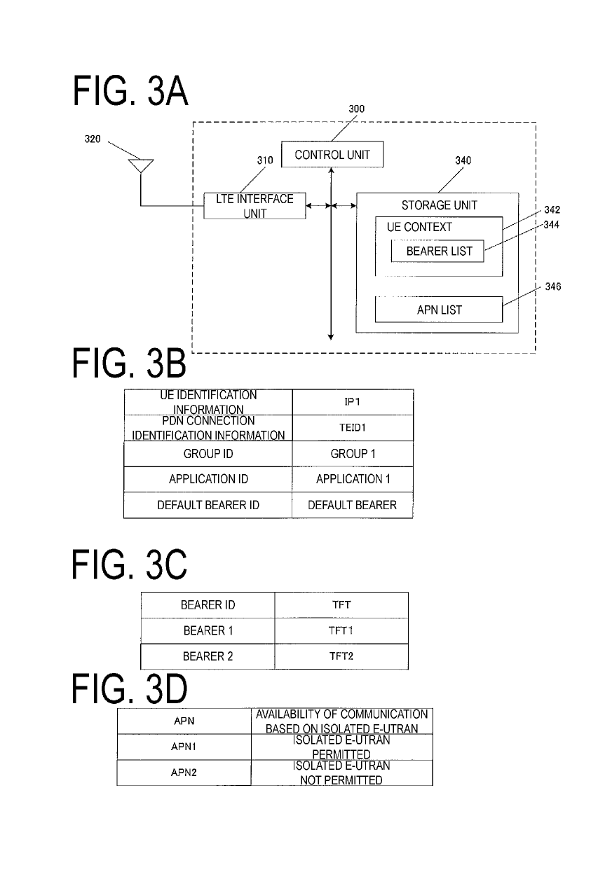

The constitution of the UE 10 is illustrated in FIG. 3 (a). Note that the constitution of the UE 20 is equivalent to the constitution of the UE 10. Therefore, detailed description of the constitution of the UE 20 will be omitted. As illustrated in the drawing, the UE 10 is constituted by an LTE interface unit 310, a control unit 300, and a storage unit 340. The LTE interface unit 310 and the storage unit 340 are connected to the control unit 300 via a bus.

The control unit 300 is a functional part for controlling the UE 10. The control unit 300 accomplishes various processes by reading out and executing various programs which are stored in the storage unit 340.

The LTE interface unit 310 is a functional part by which the UE 10 is to connect to an LTE base station, and to an IP access network. An external antenna 320 is connected to the LTE interface unit 110.

At least, a UE context 342 and an APN list 346 are stored in the storage unit 340.

Identification information for the UE, and other such information groups employed for the UE to communicate are kept in the UE context 342.

The UE identification information may be information for identifying the UE. For example, the UE identification information may be the IP address of the UE, as illustrated in FIG. 3 (b). Alternatively, the UE identification information may be an International Mobile Subscriber Identity (IMSI). Alternatively, the UE identification information may be a Globally Unique Temporary Identity (GUTI). Alternatively, the UE identification information may be an SAE Temporary Mobile Subscriber Identity (S-TMSI). At least one element of these information elements may be stored. Alternatively, the UE identification information may be information elements that combine these information elements.

Further, information groups that are associated with a PDN connection established with a core network by the UE may be stored in the UE context 342. Specifically, as illustrated in FIG. 3 (b), PDN connection identification information, identification information of the group to which the UE 10 belongs, application identification information identifying applications for which communication based on the Isolated E-UTRAN function is permitted, and a default bearer ID are included. In addition, UE context information stored in a conventional UE, such as a Tracking Area Identifier (TAI) List, may be stored.

Here, the PDN connection identification information may be information that identifies a PDN connection, and could be, for example, a Tunnel Endpoint IDentifier (TEID) of a PGW as illustrated in FIG. 3(b). Alternatively, the PDN connection identification information may be an IP address. Alternatively, the PDN connection identification information may be a combination of these. Note that the PDN connection identified by the identification information may be a communication-dedicated PDN connection based on the Isolated E-UTRAN function.

The group ID is an information element identifying the group to which the UE 10 belongs. Multiple group IDs may be stored.

Further, an APN corresponding to a PDN to which a PDN connection has established connectivity may be stored. For example, when a PDN connection for communication based on the Isolated E-UTRAN function has been established, the UE stores an APN for which communication based on the Isolated E-UTRAN function has been permitted.

A UE may establish multiple PDN connections. When a UE has established multiple PDN connections, information groups associated with the PDN connections are stored for each of the PDN connections, in the UE context 342. The UE may also manage a bearer list 344, included in the information groups associated with the PDN connections.

The bearer list 344 is a list of bearer IDs that identify a bearer, other than the default bearer, for each PDN connection identified by the UE context 342. Multiple bearer IDs may be stored, as illustrated in FIG. 3 (c). Further, a Traffic Flow Template (TFT) assigned to each bearer may be stored as well.

Here, a TFT refers to flow identification information that identifies user data transmitted or received by the UE. A TFT constitution, may include a combination of one or more of the IP address of the transmission source, the IP address of the transmission destination, the port number of the transmission source, the port number of the transmission destination, the protocol number, application identification information, and the like. In this way, a TFT may be information that identifies an application to which user data transmitted or received by the UE corresponds.

Note that a UE may establish multiple bearers for a single PDN connection. Therefore, when a UE has established multiple bearers for a PDN connection, multiple items of bearer identification information may be stored. In the process, the UE associates a TFT with each bearer, and stores the information. By so doing, the UE can select a bearer of the transmission destination when transmitting user data.

At least one or more available APNs can be stored in an APN list 346. APNs may be designed such that a different service is permitted for each APN. For example, as illustrated in FIG. 3 (d), the availability of communication based on the Isolated E-UTRAN function may be identified from identification information indicating that communication based on the Isolated E-UTRAN function is permitted, and identification information indicating that communication based on the Isolated E-UTRAN function is not permitted.

In FIG. 3 (d), for example, an APN1 may be an APN for which communication based on the Isolated E-UTRAN function is permitted, and an APN2 may be an APN for which a telephone service is permitted, while communication based on the Isolated E-UTRAN function is not permitted.

That is, the APN1 can be used to establish a PDN connection for communication based on the Isolated E-UTRAN function, while at the same time the APN2 can be used to establish a PDN connection for communication such as conventional telephone service.

Further, APNs may be associated with even more fine-grained service-permission information. For example, identification information indicating that communication based on the Isolated E-UTRAN function is permitted may be identification information identifying when communication based on an Isolated E-UTRAN state A is permitted, and when communication based on an Isolated E-UTRAN state B is permitted.

Specifically, identification information indicating the availability of communication based on the Isolated E-UTRAN function may be identification information identifying when communication based on the Isolated E-UTRAN function is permitted in the Isolated E-UTRAN state A, identification information identifying when communication based on the Isolated E-UTRAN function is permitted in the Isolated E-UTRAN state B, or identification information identifying when communication based on the Isolated E-UTRAN function is permitted in both states.

Alternatively, the information may be identification information indicating that communication based on the Isolated E-UTRAN function is not permitted in the Isolated E-UTRAN state A, identification information indicating that communication based on the Isolated E-UTRAN function is not permitted in the Isolated E-UTRAN state B, or identification information indicating that communication based on the Isolated E-UTRAN function is not permitted in both states.

Alternatively, identification information may indicate that communication based on the Isolated E-UTRAN function is permitted in one state, and that communication based on the Isolated E-UTRAN function is not permitted in another state.

In this way, UEs may store a plurality of APNs for each type of communication permitted on the basis of this permission information.

### 1.2.2. eNB Constitution Diagram

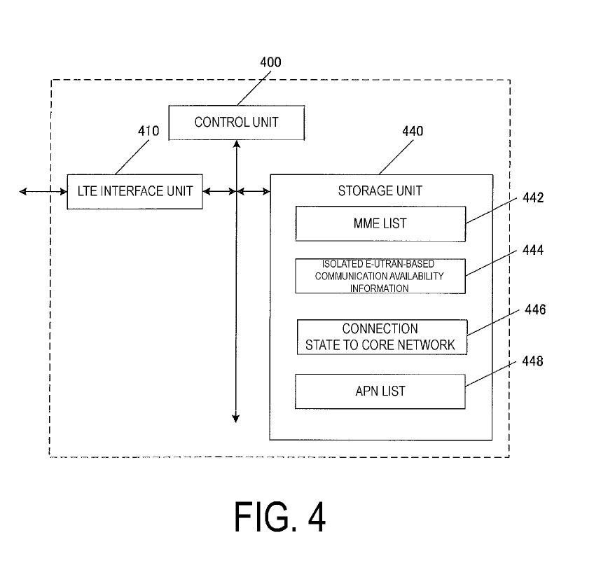

FIG. 4 illustrates the constitution of the eNB 45. As illustrated in the drawing, the eNB 45 is constituted by an LTE interface unit 410, a control unit 400, and a storage unit 440. The LTE interface unit 410 and the storage unit 440 are connected to the control unit 400 via a bus.

The control unit 400 is a functional part for controlling the eNB 45. The control unit 400 accomplishes various processes by reading out and executing various programs which are stored in the storage unit 440.

As illustrated in the drawing, the storage unit 440 stores, at least, an MME list 442, Isolated E-UTRAN function-based communication availability information 444, and a connection state to a core network 446.

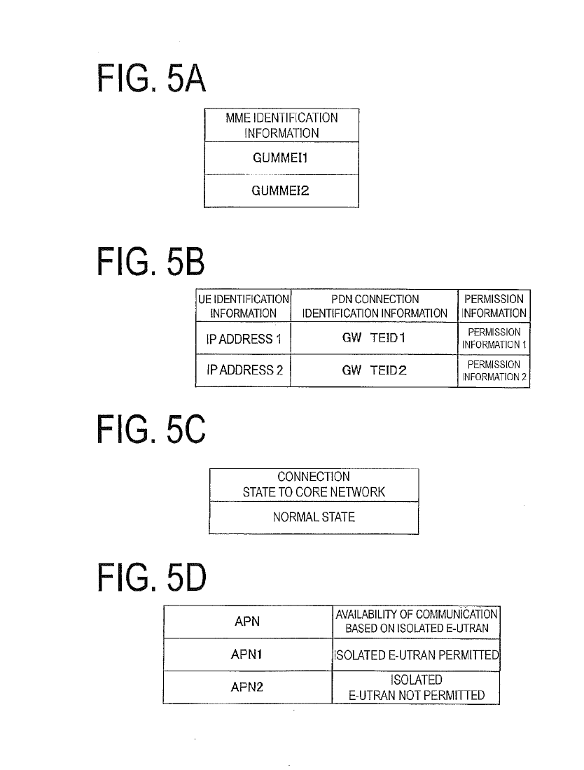

FIG. 5 illustrates an example of information elements included in the storage unit 440. As illustrated in FIG. 5 (a), identification information identifying MMEs to which the eNB 45 can connect is stored in the MME list 442. Here, the MME identification information may be a Globally Unique MME Identifier (GUMMEI), or an MME identifier (MME ID).

Further, as illustrated in FIG. 5 (b), UE identification information, and/or PDN connection identification information and Isolated E-UTRAN function-based communication availability information, are/is saved in the Isolated E-UTRAN function-based communication availability information 444.

Here, the UE identification information may be information that identifies the UE. For example, the UE identification information may be the IP address of the UE, as illustrated in FIG. 3 (b). Alternatively, the UE identification information may be an International Mobile Subscriber Identity (IMSI). Alternatively, the UE identification information may be a Globally Unique Temporary Identity (GUTI). Alternatively, the UE identification information may be an SAE Temporary Mobile Subscriber Identity (S-TMSI). At least one element of these information elements may be stored. Alternatively, the UE identification information may be information elements that combine these information elements.

Alternatively, the PDN connection identification information may be information that identifies the PDN connection. For example, the PDN connection identification information may be a Tunnel Endpoint IDentifier (TEID) of a PGW as illustrated in FIG. 5 (b). Alternatively, the PDN connection identification information may also be an IP address. Alternatively, the PDN connection identification information may be a combination of these.

The connection state to the core network 7 by the LTE access network to which the eNB 45 belongs is saved in the connection state to a core network 446. For example, as illustrated in FIG. 5 (c), when the backhaul 2 is maintaining normal connectivity, the connection state to a core network 446 would be considered as the normal state, whereas a state in which the backhaul 2 has completely lost connectivity, or the state of the LTE access network when it has become necessary to limit communication using the backhaul 2, would be considered as the Isolated E-UTRAN state. The Isolated E-UTRAN state may be a communication state in which user data transmitted by a UE is delivered to other UEs by the base station as an anchor device.

Further, a distinction may be made between a state of an LTE access network in which the backhaul 2 has completely lost connectivity, denoted as Isolated E-UTRAN state A, and a state of an LTE access network when it has become necessary to limit communication using the backhaul 2, denoted as Isolated E-UTRAN state B.

Further, the storage unit 440 may store a list 448 of APNs for which communication based on the Isolated E-UTRAN function is permitted.

The APN list 448 can store at least one or more available APNs. A different service may be permitted for each APNh or APN. For example, as illustrated in FIG. 5 (d), the availability of communication based on the Isolated E-UTRAN function may be identified by identification information indicating that communication based on the Isolated E-UTRAN function is permitted, and by identification information indicating that communication based on the Isolated E-UTRAN is not permitted.

In FIG. 5 (d), for example, the APN1 may be an APN for which communication based on the Isolated E-UTRAN function is permitted, and the APN2 may be an APN for which telephone service is permitted, and communication based on the Isolated E-UTRAN function is not permitted.

That is, the APN1 can be used to establish a communication-dedicated PDN connection based on the Isolated E-UTRAN function, while at the same time the APN2 can be used to establish a communication-dedicated PDN connection such as conventional telephone service.

Further, APNs may be associated with even more fine-grained service-permission information. For example, identification information indicating that communication based on the Isolated E-UTRAN function is permitted may be identification information identifying when communication based on an Isolated E-UTRAN state A is permitted, and when communication based on an Isolated E-UTRAN state B is permitted. A specific description would be the same as for the APN list of FIG. 3 (d), and is therefore omitted.

Further, a TAI list for each connected terminal may be stored in the storage unit 440. Further, the TAI to which each terminal is currently connected may be stored as well.

### 1.3. Description of Process

1.3.1 Method for switching to communication based on Isolated E-UTRAN Function

The method for transitioning the state of an LTE access network from the E-UTRAN state to the Isolated E-UTRAN state, and switching communication between terminals to communication based on the Isolated E-UTRAN function will be described below.

In the present embodiment, the Isolated E-UTRAN state A and the Isolated E-UTRAN state may be identified.

Additionally, in the present embodiment, an APN for which communication based on the Isolated E-UTRAN function is permitted is called APN1, and an APN for which communication based on the Isolated E-UTRAN function is not permitted is called APN2.

In the initial state, with the state of the access network in the normal state (E-UTRAN), the UE 10, using the APN1 and the APN2, respectively establishes PDN connections to the core network 7 which includes the MME 40, by a conventional attach request procedure.

It should be noted that in the present embodiment, for simplicity, the PDN connections are established with an APN1 and an APN2, but there is no limit as to the number of APNs used to establish PDN connections, and respective PDN connections may be established using three or more APNs.

It should also be noted that these PDN connections established in the initial state may be PDN connections established between the UE 10 and a PGW 30 included in the core network. Also, the PGW that is the end point of the PDN connection established using APN1, and the PGW that is the end point of the PDN connection established using APN2, are PGWs selected by the MME 40, and may be the same PGW or different PGWs.

Additionally, the eNB 45 may manage UEs for which connection when the system has transitioned to the Isolated E-UTRAN state is permitted. Further, the eNGB 45 may keep permission information indicating that the UE 10 is a UE for which communication based on the Isolated E-UTRAN function is permitted, and may permit connection on the basis of the permission information. A connection to a UE for which permission information is not kept may be rejected.

At this time, the UE 10 may provide notice of the permission information indicating that the UE 10 is a UE for which communication based on the Isolated E-UTRAN function is permitted.

Specifically, the permission information may be an APN transmitted by the UE 10. The eNB 45 may generate permission information because the APN transmitted by the UE 10 is the APN1 for which communication based on the Isolated E-UTRAN function is permitted. Alternatively, permission information may be kept as information which is written to the terminal when the UE is shipped from the factory, and to announce, to the eNB 45, the permission information. Alternatively, the user may configure the UE 10 in advance to request communication based on the Isolated E-UTRAN function, and announce, to the eNB 45, the permission information, on the basis of the configuration.

The UE 10 may also provide notice of permission information by including the information in a control message transmitted to the eNB 45 during the attach procedure. The control message to the eNB 45 from a UE included in the attach procedure may be an attach request message. Alternatively, permission information indicating that communication based on the Isolated E-UTRAN function is permitted for the UE 10 may be information of which is announced from the MME 40.

Specifically, the MME 40 may generate permission information because the APN to which the UE 10 was assigned is an APN1, and to announce, to the eNB 45, the information. Alternatively, the MME 40 may inquire the HSS 50 for the UE 10 subscriber information, generate permission information on the basis of the subscriber information, and announce, to the eNB 45, the information.

Alternatively, a UE may announce, to the MME 40, permission information by a control signal transmitted to the MME from a UE included in an attach request message or other attach procedure, and for the MME 40 to announce, to the eNB 45, the permission information in response to the receiving of the permission information.

Alternatively, the HSS 50 may store permission information linked to UE 10 subscriber information, for the HSS 50 to announce, to the MME 40, the permission information in an attach procedure initiated by the UE 10, and for the MME 40 to then announce, to the eNB 45, the permission information in response to the receiving of the permission information.

It should be noted that the MME 40 may announce, to the eNB 45, by including the permission information in an attach-permission message, or announce, to the eNB 45, by including the information in a different message independent from an attach-permission message.

The HSS 50 may use a control message to the MME 40 included in an attach procedure, to announce, to the MME 40, permission information.

Also, the eNB 45 may be provided with a local MME function having some of the functions of the MME 40, so as to be able to function as a position management device in place of the MME 40 in the Isolated E-UTRAN state. Further, in order for the eNB 45 to acquire some of the functions of the MME 40, the eNB 45 may acquire from the MME 40 an information group necessary for the local MME function, doing so in the normal state prior to transition to the Isolated E-UTRAN state.

Specifically, because the eNB 45 has a function for storing a UE context, the eNB 45 transmits permission information to the MME 40 in the attach procedure. In response to having acquired permission information from the eNB 45, the MME 40 transfers the UE context to the eNB 45.

At this time, the MME 40 may announce, to the eNB 45, a list of APNs composed of a plurality of APNs including an APN1.

Transfer of the UE context and/or transfer of the APN list may be executed by a control message to the eNB 45 from the MME 40 included in the attach procedure.

Note that the eNB 45 may store identification information identifying that the eNB 45 has some of the functions of the MME 40, and/or identification information representing capability information indicating the possibility for the eNB 45 to have some of the functions of the MME 40, and/or identification information identifying that the eNB 45 has an Isolated E-UTRAN function. The eNB 45 may announce, to the MME 40, identification information by using a control signal.

More specifically, the eNB 45 may announce identification information by including the information in a control message which is transmitted to the MME 40 by the eNB 45 in the attach procedure, announce identification information by including the information in a control message which is transmitted to the MME 40 by the eNB 45 after completion of the attach procedure, or announce identification information by including the information in a control message which is transmitted to the MME 40 by the eNB 45 prior to the attach procedure.

The MME 40 may transfer a UE context and/or an APN list to the eNB 45 on the basis of the identification information.

In this way, in the initial state of the present embodiment, the UE 10 connects to the core network 7 through a procedure based on the attach procedure (S602). Further, by a PDN connection establishment procedure or an attach procedure using an APN1, the UE 10 establishes a PDN connection for which communication is permitted in the Isolated E-UTRAN state. Also, the UE 10 may further establish a PDN connection for which communication is not permitted in the Isolated E-UTRAN state, by a PDN connection establishment procedure or an attach procedure using an APN2. The eNB 45 also acquires permission information regarding communication by the UE 10 based on the Isolated E-UTRAN function.

The process leading to the initial state in the present embodiment was described above, and such a process may be executed for multiple UE connecting to the eNB 45, such as the UE 20, irrespective of the UE 10.

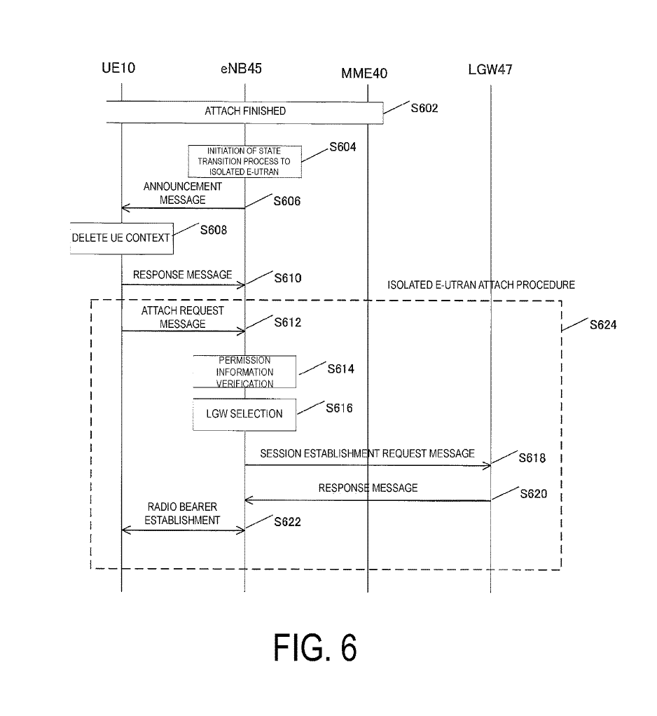

Next, a LTE access network state transition process and a PDN connection switching method will be described, while referring to FIG. 6.

The eNB 45 initiates a state transition process to the Isolated E-UTRAN state in which connectivity of the backhaul 2 has been lost, or it is necessary to limit communications via the backhaul 2 (S604).

The Isolated E-UTRAN state at this time refers to a state in which, for example, due to a disaster or the like the physical connectivity from the eNB 45 to the core network has been lost, or the LTE access network to which the eNB 45 belongs has changed due to movement by an eNB that is mobile (a Nomadic eNB), and the LTE access network which is a change destination has no connection to the core network. Alternatively, referred to here are states in which connectivity from the eNB 45 to the core network has been lost, or limitations have become necessary, due to various other factors.

The initiation trigger for a state transition process may be, for example, a loss of connectivity by the interface (S1-U) between the eNB 45 and the SGW 35.

Alternatively, the initiation trigger for a state transition process may also be a loss of connectivity by the interface (S1-MME) between the eNB 45 and the MME 40. Alternatively, both events may be triggers.

The eNB 45 may automatically initiate the state transition process, in association with detection of these triggers.

Alternatively, the eNB 45 may be made to initiate the state transition process by a manual operation by a carrier (an administrator of the operator).

In the state transition process, the eNB 45 first transmits an announcement message to the UE 10 (S606). The announcement message may be a message requesting the UE 10 to detach, and/or a message requesting initiation of an attach procedure, and/or a message announcing the connection state (the Isolated E-UTRAN state A and/or the Isolated E-UTRAN state B) to the core network 7 to which the eNB 45 attempts to transition, and/or a message announcing a list of UEs currently present within the communication coverage of the eNB 45. Notification messages may be messages having at least one of these meanings. Alternatively, these messages may take the form of announcements through individual messages.

It should be noted that announcement messages may include an information element identifying the connection state to a core network.

Specifically, announcement messages may include identification information indicating that the connection state to a core network to which the NB 45 attempts to transition is the Isolated E-UTRAN state A, or include identification information indicating that the connection state is the Isolated E-UTRAN state B; or be identification information indicating that the connection state is the Isolated E-UTRAN state (the Isolated E-UTRAN state A and the Isolated E-UTRAN state B).

The eNB 45 may also include in the announcement message to the UE 10 a list of UEs currently present within the communication coverage of the eNB 45. For example, when the UE 20 is connected to the core network 7 via an LTE access network in the normal state, the eNB 45 may store this information, and include identification information identifying the UE 20 in the announcement message that is transmitted to the UE 10 in S606. The eNB 45 may include identification information of the UE 20 in an announcement message, on the basis of whether the UE 20 belongs to the same group as the UE 10.

The eNB 45 may include the APN1 in an announcement message transmitted to the UE 10, and announce that a PDN connection which can be re-established is a PDN connection established using an APN for which communication based on the Isolated E-UTRAN function is permitted.

The announcement message may be a conventional detach request message transmitted from an MME to a UE (a non-access layer: layer 3).

Further, the eNB 45 may transmit to the UE 10 a message that includes a detach request message including a cause value indicating a need for an attachment.

Additionally, in this case, the eNB 45 has, by way of some of the functions of an MME, a function whereby the eNB 45 stores the UE context of the UE 10, a function whereby transmitting and receiving of non-access layer control messages is possible, or a function of transmitting a detach request message, in place of the MME 40.

Also, the announcement message of S606 may be a layer 2 level message, and the message may request release of a radio resource, by deleting from the UE 10 information that is included in the UE context and indicates that the UE 10 is in a connection state to the core network 7.

For example, the eNB 45 transmits to the UE 10 an announcement message including application identification information identifying an application for which communication based on the Isolated E-UTRAN function has been permitted.

Here, the application identification information may be identification information managed by a specific application server, or identification information managed by the eNB 45. The eNB 45 requests release of the radio resource that was established for the application which is identified by the application identification information in the announcement message.

Alternatively, the eNB 45 includes in the announcement message transmitted to the UE 10 a radio bearer ID identifying a bearer. Through the announcement message, the eNB 45 requests deletion of information relating to the radio bearer ID.

Note that an announcement message of layer 2 level transmitted from the eNB 45 to the UE 10 may also be a radio resource control (RRC) connection re-establishment message.

Specifically, the announcement message of layer 2 level transmitted from the eNB 45 to the UE 10 may be a control message for RRC connection. More specifically, the announcement message may be a radio resource block establishment message, a radio resource change message, or a radio resource block release message.

Further, the eNB 45 may transmit to the UE 10 an announcement message that includes a cause value indicating a need for an attachment.

In this case, the eNB 45 has some of the functions of an MME. Specifically, the eNB 45 has the function of storing the UE context.

The eNB 45 may also decide to transmit a radio resource block establishment message, a radio resource change message, or a radio resource block release message, in place of the MME 40. For example, when the connection state of the eNB 45 and the UE 10 is an active state and/or a connected state, the eNB 45 may decide to transmit a radio resource block release message.

The eNB 45 may also transmit to the UE 10 broadcast information announcing that the eNB 45 has initiated a state transition process to the Isolated E-UTRAN state. The broadcast information may include a TFT, or a bearer ID that specifies a bearer for permitting to communicate on the basis of the Isolated E-UTRAN function, or identification information about an application for permitting to communicate on the basis of the Isolated E-UTRAN function. Here, the eNB 45 may transmit the broadcast information in the form of an announcement message, or transmit the broadcast information separately as a message different from the announcement message.

The UE 10 receives the announcement message from the eNB 45. When the announcement message received by the UE 10 is a message requesting the UE 10 to initiate a detach and attach procedure, the UE 10 deletes the UE context 342 or the bearer list 344 from the storage unit 340, in response to the receiving of the announcement message (S608).

Further, when the announcement message that the UE 10 has received from the eNB 45 is layer 2 level, the UE 10 releases the specified radio resource. For example, when application identification information is included in a message, the radio resource that was established by the application identified is released. Additionally, when a radio bearer ID is included in a message, the eNB 45 releases the radio resource that was allocated to the radio bearer ID.

On the other hand, when an announcement message received from the eNB 45 by the UE 10 is a layer 3 message containing PDN connection identification information, the eNB 45 deletes the UE context that relates to the specified PDN connection. Further, a response message to the announcement message may be transmitted to the eNB 45 (S610). The response message is a detach response message, which is a message announcing that detachment has been completed.

The eNB 45 receives a response message to the announcement message from the UE 10. The eNB 45 may delete the identification information of the UE 10 from the storage unit, in response to the receiving of the response message. Alternatively, information may be deleted from the storage unit when having received from the UE 10 an attach request message for an Isolated E-UTRAN attach procedure; or after starting a timer, storing the information until the count of the timer is full.

In this way, the eNB 45 transitions to the Isolated E-UTRAN state when triggered by reception of a detach procedure and/or a response message from the UE 10, and/or the count of the timer being full.

Next, the UE 10 executes an attach procedure and establishes a PDN connection to communicate on the basis of the Isolated E-UTRAN function (S624). Here, the attach procedure is expressed as an Isolated E-UTRAN attach procedure, to distinguish it from a conventional attach procedure.

Further, in response to the receiving of the announcement message, the UE 10 transmits an attach request message to the eNB 45 (S612). The attach request message may include the response message of S610, or the attach request message may include the APN1. Note that the APN1 need not necessarily be transmitted by the UE 10 by inclusion thereof in the attach request message, and the APN1 may be transmitted by inclusion in a control message that is transmitted to the eNB 45 by the UE 10 within the attach procedure. The UE 10 may select and transmit the APN1 of a plurality of APNs kept in an APN list, in response to the announcement message transmitted by the eNB 45. More specifically, the UE 10 may select the APN1 because the announcement message indicates that re-establishment using the APN1 is permitted.

When this sort of selection means is unavailable, the UE 10 may announce, to the eNB45, the APN1 and APN2 through an Isolated E-UTRAN attach procedure or a PDN connection establishment procedure.

The eNB 45 receives the attach request message from the UE 10. The attach request method at this time may include the APN1. Alternatively, the APN1 may be included in another control message transmitted to the UE 10 from the eNB 45, included in the attach procedure.

When an APN for which communication based on the Isolated E-UTRAN function is permitted is not stored by the eNB 45, the APN1 and the APN2 may be included in an attach request message.

In response to the receiving of an APN, the eNB 45 verifies the permission information presented to the UE 10 (S614).

The eNB 45 may decide whether to permit the establishment of a PDN connection for each APN, on the basis of the Isolated E-UTRAN state. For example, the eNB 45 may permit the establishment of a PDN connection based on the APN1 for which communication based on Isolated E-UTRAN function has been permitted, and reject establishment of a PDN connection based on the APN2.

Further, the eNB 45, having permitted establishment of a PDN connection, may select the LGW 47 as the gateway for use in the PDN connection, because the state of the LTE access network to which the eNB 45 belongs is the Isolated E-UTRAN state, or the Isolated E-UTRAN state A (S616).

The eNB 45 transmits a session establishment request message to the selected gateway LGW 47 (S618). The session establishment request message includes at least identification information of the UE 10, and the APN1.

The LGW 47 receives the session establishment request message from the eNB 45. The received message includes at least identification information of the UE 10, and the APN1. The LGW 47 assigns an IP address to the UE 10 in response to the received message.

The LGW 47 transmits to the eNB 45 a response message to the received message (S620). The response message includes at least the IP address that was assigned to the UE 10, and the TEID of the LGW 47 gateway.

In response to the receiving of the response message, the eNB 45 establishes a new radio bearer to the UE 10 (S622). When establishing the radio bearer, the eNB 45 can announce, to the UE 10, the new IP address and the TEID of the LGW.

Further, when the eNB 45 has selected the APN1 of a plurality of APNs included in the message received from the UE 10, the eNB 45 may announce, to the UE 10, identification information of the selected APN1 when the radio bearer is established.

Further, when a bearer other than the default bearer has been designated as the bearer to be utilized in communication based on the Isolated E-UTRAN function, the eNB 45 may include identification information instructing the UE 10 not to use the default bearer, when the bearer is established. The identification information at this time may be a bearer ID or TFT identifying a bearer.

Further, when an application for which communication based on the

Isolated E-UTRAN has been permitted is designated, when the radio bearer is established, the eNB 45 may announce, to the UE 10, identification information of the application for which communication based on the Isolated E-UTRAN has been permitted.

By so doing, the UE 10 can establish a PDN connection to communicate on the basis of the Isolated E-UTRAN function.

Through the above process, the Isolated E-UTRAN attach procedure is completed, and a communication-dedicated PDN connection based on the Isolated E-UTRAN function is established between the UE 10 and the eNB 45 or the LGW 47.

By completing the Isolated E-UTRAN attach procedure, in response to a state transition to the Isolated E-UTRAN state by the eNB 45, the UE 10 can switch a PDN connection that was used for communication in the normal state to a PDN connection for communication based on the Isolated E-UTRAN function, and continue with communication.

### 1.3.2. Method for Switching to Communication Based on Isolated E-UTRAN Function: First Modification

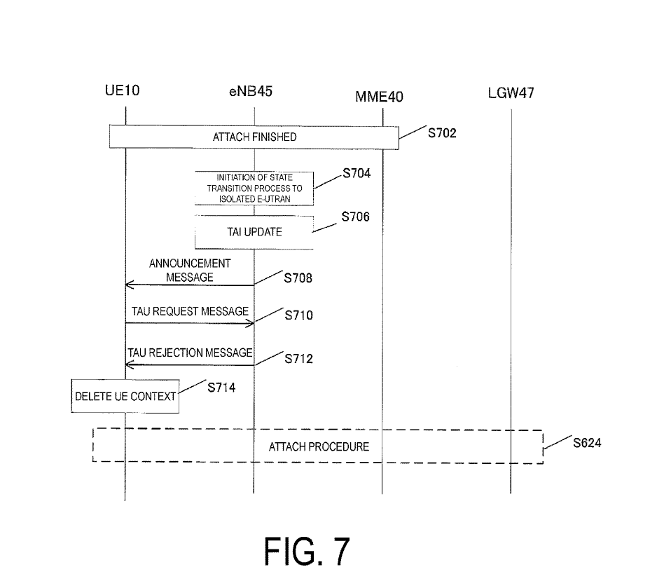

Next, a first modification, which is a communication switching procedure that involves the eNB 45 changing the TAI of the UE being managed in association with a state transition procedure to the Isolated E-UTRAN, will be described with reference to FIG. 7.

The initial conditions in the present modification are the same as the conditions described in 1.3.1, and therefore a detailed description thereof is omitted.

FIG. 7 is a diagram for illustrating the present modification. First, the UE 10 connects to the core network 7, by a procedure based on a conventional attach procedure (S702). Further, the eNB 45 acquires permission information regarding communication by the UE 10 based on the Isolated E-UTRAN function.

The eNB 45 initiates a state transition process to the Isolated E-UTRAN state, in which connectivity of the backhaul 2 has been lost, or it is necessary to limit communications via the backhaul 2 (S704).

The initiation trigger for the state transition process may be the same as the trigger for initiating the state transition process to the Isolated E-UTRAN state described in 1.3.1.

Subsequently, the state transition process is described.

First, the eNB 45 executes a TAI update process (S706). In the TAI update process, the eNB 45 may update the tracking area identification information (TAI: Tracking Area ID), in association with initiation of a switching procedure to communication based on Isolated E-UTRAN. Specifically, the eNB 45 configures the TAI to one different from the TAI which the eNB 45 holds in the normal state up to that point in time. It should be noted that the updated TAI may be identification information in which a tracking area code (TAC) included in the TAI has been updated. Further, the TAI newly assigned to the UE 10 may be a special TAI that has been configured because the current state is the Isolated E-UTRAN state. That is, the TAI may be a tracking area ID that indicates an area in which communication based on Isolated E-UTRAN is performed.

In response to the update of the TAI, the eNB 45 transmits an announcement message to the UE 10 (S708). The announcement message may be a message announcing, to the UE 10, the update of the TAI, and/or a message announcing the connection state to the core network 7 to which the eNB 45 attempts to transition (the Isolated E-UTRAN state A and/or the Isolated E-UTRAN state B), and/or a layer 2 announcement message requesting release of a radio resource. Notification messages may be messages having at least one of these meanings. Alternatively, these messages may take the form of announcements through individual messages. These messages may also be broadcast information transmitted to the UE 10 by the eNB 45.

When an announcement message is a message announcing an update of the TAI, the eNB 45 may include in the announcement message the new TAI assigned to the UE 10.

The UE 10 receives the announcement message from the eNB 45, and in response to the receiving of the announcement message, the UE 10 transmits a TAU (Tracking Area Update) request message to the eNB 45 (S710).

Specifically, when a new TAI is included in the message received by the UE 10, the UE 10 may verify that no new TAI is included in the TAI list stored by the UE 10, and on the basis of the verification the UE 10 may then transmit a TAU request message to the eNB 45.

Additionally, a message received by the UE 10 may be verified as a message announcing a connection state to the core network 7 to which the eNB 45 attempts to transition, and the UE 10 may then transmit a TAU request message to the eNB 45 in response to the received message.

Additionally, the UE 10 may transmit a TAU request message, on the basis of a case in which the UE 10 is a layer 2 announcement message requesting release of a radio resource from the eNB 45.

Note that the TAU request message may include the updated, new TAI.

The eNB 45 receives the TAU request message from the UE 10. Because the connection state of the eNB 45 to the core network is the Isolated E-UTRAN state, the eNB 45 performs an authentication procedure for the TAU request, in place of the MME 40. The eNB 45 may transmit a rejection message in response to the TAU request message (S712).

Specifically, when a TAI that is different from the TAI newly assigned by the eNB 45 is included in a TAU request message received by the eNB 45, the eNB 45 can reject the TAU request. Alternatively, because of the state being the Isolated E-UTRAN state, the eNB 45 may reject the TAU request, and delete the UE context that corresponds to the UE 10.

The eNB 45 may include in the TAU rejection message, as a cause value as to why the TAU procedure cannot be performed, a value indicating an implicit detach request, and/or a value indicating that UE identification information could not be acquired from the network.

Further, the TAU rejection message may include a message requesting deletion of a Globally Unique Temporary Identifier (GUTI) stored by the UE.

In response to the receiving of the TAU rejection message from the eNB 45, the UE 10 deletes the UE context (S714). Through the above process, the eNB 45 transitions to the Isolated E-UTRAN state.

Further, the UE 10 initiates an attach procedure via the eNB 45 in the Isolated E-UTRAN state (S624).

The Isolated E-UTRAN attach procedure method is the same as in S624 of FIG. 6, and therefore a detailed description of the method is omitted.

Through the above process, the procedure for switching to communication based on the Isolated E-UTRAN function can be accomplished through an update of the TAI by the eNB 45.

1.3.3. Method for Switching to Communication based on Isolated E-UTRAN Function: Second Modification

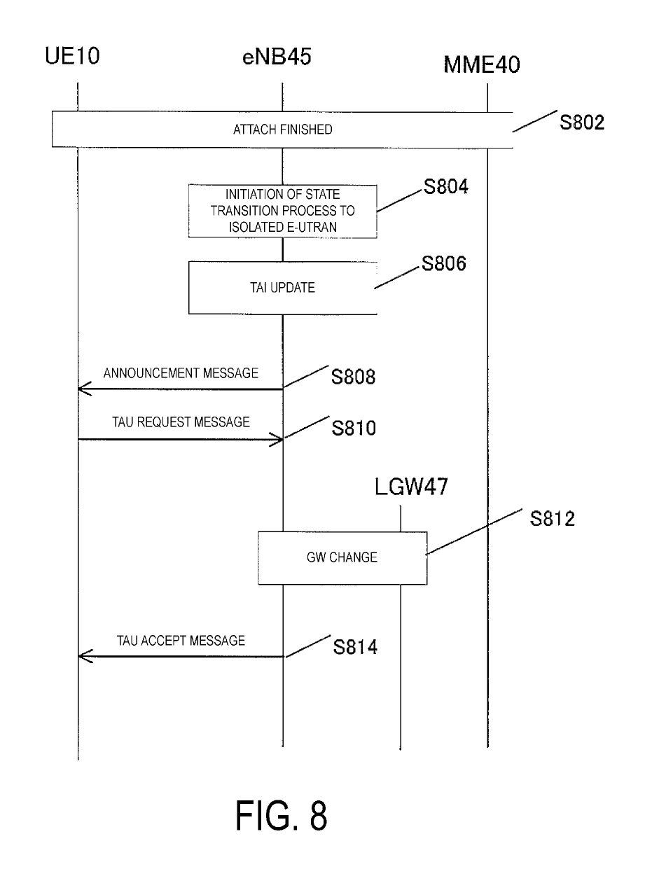

Next, a second modification, which is a communication switching procedure that involves the eNB 45 changing the TAI in association with initiation of a state transition procedure to the Isolated E-UTRAN state, will be described with reference to FIG. 8. The present modification is a communication switching procedure that involves changing the gateway used for a PDN connection.

Note that the initial conditions in the present modification are the same as the conditions described in 1.3.1, and therefore a detailed description thereof is omitted.

FIG. 8 is a diagram for illustrating the present modification. First, the UE 10 connects to the core network 7 by a procedure based on the conventional attach procedure (S802). Further, the eNB 45 acquires permission information regarding communication by the UE 10 based on the Isolated E-UTRAN function. The eNB 45 initiates a state transition process to the Isolated E-UTRAN state in which connectivity of the backhaul 2 has been lost, or it is necessary to limit communications via the backhaul 2 (S804).

Note that the initiation trigger for the state transition process may be similar to the trigger for initiating the state transition process to the Isolated E-UTRAN state described in 1.3.1.

Subsequently, the state transition process is described.

First, the eNB 45 executes a TAI update process (S806). Here, the TAI update process may be similar to the TAI update process described in 1.3.2 (S706), and therefore a detailed description will be omitted. In response to the update of the TAI, the eNB 45 transmits an announcement message to the UE 10 (S808). The announcement message may be a message announcing, to the UE 10, the update of the TAI, and/or a message announcing the connection state to the core network 7 to which the eNB 45 attempts to transition (the Isolated E-UTRAN state A and/or the Isolated E-UTRAN state B), and/or a layer 2 announcement message requesting release of a radio resource. Notification messages may be messages having at least one of these meanings. Alternatively, these messages may take the form of announcements through individual messages. These messages may also be broadcast information transmitted to the UE 10 by the eNB 45.

When an announcement message is a message announcing an update of the TAI, the eNB 45 may include in the announcement message the new TAI assigned to the UE 10.

The UE 10 receives the announcement message from the eNB 45, and in response to the receiving of the announcement message, the UE 10 transmits a TAU (Tracking Area Update) request message to the eNB 45 (S810).

Specifically, when a new TAI is included in the message received by the UE 10, the UE 10 may verify that no new TAI is included in the TAI list stored by the UE 10, and on the basis of the verification the UE 10 may then transmit a TAU request message to the eNB 45.

Additionally, a message received by the UE 10 may be verified as a message announcing a connection state to the core network 7 to which the eNB 45 attempts to transition, and the UE 10 may then transmit a TAU request message to the eNB 45 in response to the received message.

Alternatively, the UE 10 may initiate a TAU procedure on the basis of a case in which the UE 10 is a layer 2 announcement message requesting release of a radio resource from the eNB 45.

Note that the TAU request message may include the updated, new TAI.

In response to the receiving of the TAU request message, the eNB 45 verifies the permission information of the UE 10. When communication based on the Isolated E-UTRAN function is permitted for the UE 10, the eNB 45 may change the gateway used for the PDN connection to the LGW 47 (S812).

Triggered by having changed the gateway used for the PDN connection configured to perform communication based on the Isolated E-UTRAN function, the eNB 45 transmits an attach accept message to the UE 10 (S814).

The attach accept message may include the TEID, IP address, and the like of the selected LGW 47. The UE 10 may also use the received LGW 47 information as identification information of the PDN connection, and as the IP address of the UE. In the process, in association with the change of the gateway, the eNB 45 may assign a new IP address to the UE 10, and announce, to the UE 10, the change of IP address. Alternatively, the eNB 45 may continue to assign the same IP address, without changing the IP address.

Through the above process, the procedure for switching to communication based on the Isolated E-UTRAN function can be accomplished through an update of the TAI by the eNB 45. It should be noted that in the present modification, the UE 10 does not require a detach procedure and an attach procedure. That is, the UE 10 can continue to communicate without re-establishing a PDN connection. In other words, in the PDN connection that the UE 10 uses to communicate, the PGW serving as the end point of the PDN connection changes from the PGW 30 before the TAU, to the LGE 47 thereafter.

Note that when the IP address is changed on the basis of a TAU, the UE 10 updates the IP address and continues communication. Alternatively, when the IP address has not changed on the basis of a TAU, the UE 10 may perform communication using the same IP address both before and after the TAU.

1.3.4. Method for Communication between UEs in Isolated E-UTRAN

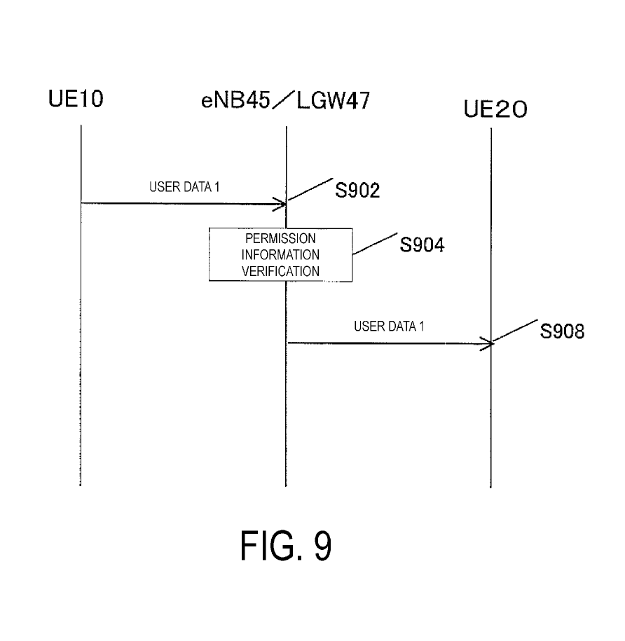

Next, a method for communication between UEs based on the Isolated E-UTRAN function will be described. FIG. 9 is a diagram for illustrating a communication method between UEs.

After a switching procedure to communication in Isolated E-UTRAN has been completed, when user data for the UE 20 has been generated in the UE 10, the UE 10 transmits user data 1 to the eNB 45 (S902).

When the UE 10 has received a UE list from the eNB 45 in the course of the switching procedure to communication based on the Isolated E-UTRAN function, the UE 10 may initiate transmission of the user data upon verifying that the recipient UE is present in the UE list.

Specifically, in the course of the switching procedure to communication based on the Isolated E-UTRAN function, the eNB 45 transmits to the UE 10 a list of UEs with which it is possible for the UE 10 to communicate on the basis of the Isolated E-UTRAN function. At this time, identification information of the UE 20 is included in the UE list.

The UE 10 verifies that the UE 20 is included in the list that was received from the eNB 45, and transmits the user data destined for the UE 20 to the eNB 45.

The UE 10 transmits, to the eNB 45, together with the user data 1, identification information of the UE 10 and the UE 20, and/or identification information of the PDN connection.

The eNB 45 receives the user data 1 from the UE 10. On the basis of the UE identification information and/or the PDN connection identification information which were transmitted together with the user data, the eNB 45 verifies permission information indicating whether communication based on the Isolated E-UTRAN function is permitted for the UE 10 and the UE 20 (S904).

When the eNB 45 cannot verify permission information for the UE 10 and/or the UE 20, the eNB 45 halts the user 1 transfer procedure. In such a case, the eNB 45 may announce, to the UE 10, the data transfer failure.

When the eNB 45 transmits to the UE 10 an announcement message announcing a user data transfer failure, the announcement message may include a cause value indicating that the cause of the failure was that permission information of the UE 10 and/or the UE 20 could not be verified.

In a case in which, as a result of verification of permission information by the eNB 45, permission information for the UE 10 and the UE 20 was successfully verified, the eNB 45 transfers, on the basis of the permission information, the user data 1 to the UE 20, using a communication-dedicated PDN connection based on the Isolated E-UTRAN function (S908).

In the course of the switching procedure to communication based on the Isolated E-UTRAN function by the UE 10 and the UE 20, when the LGW 47 has been selected as the gateway for use in the PDN connection, the user data 1 may be transferred to the UE 20 via the LGW 47.

Through the above process, continuous service may be achieved, when the eNB 45 is included in an Isolated E-UTRAN.

### 2. Second Embodiment

Next, a method for achieving continuous service when the eNB 45 has been included in an LTE access network in the Isolated E-UTRAN state B will be described.

Note that the system overview and device constitution are equivalent to those of the first embodiment, and therefore a detailed description is omitted.

### 2.1. Description of Process

2.1.1. Method for switching to communication based on Isolated E-UTRAN function

A switching method employed when the state of an LTE access network has undergone a state transition process from the E-UTRAN state to an Isolated E-UTRAN state B is described below. In the present embodiment, a description is provided for a procedure executed when the eNB 45 and/or the MME 40 and/or the UE 10 distinguish between an Isolated E-UTRAN state A and an Isolated E-UTRAN state B, and the current state is the Isolated E-UTRAN state B. It should be noted that in the Isolated E-UTRAN state A, the eNB 45 and/or the MME 40 and/or the UE 10 may execute the procedure or process described in the first embodiment.

The initial state of the procedure may be similar to the initial state described in the first embodiment. Therefore, a detailed description of the initial state is omitted.

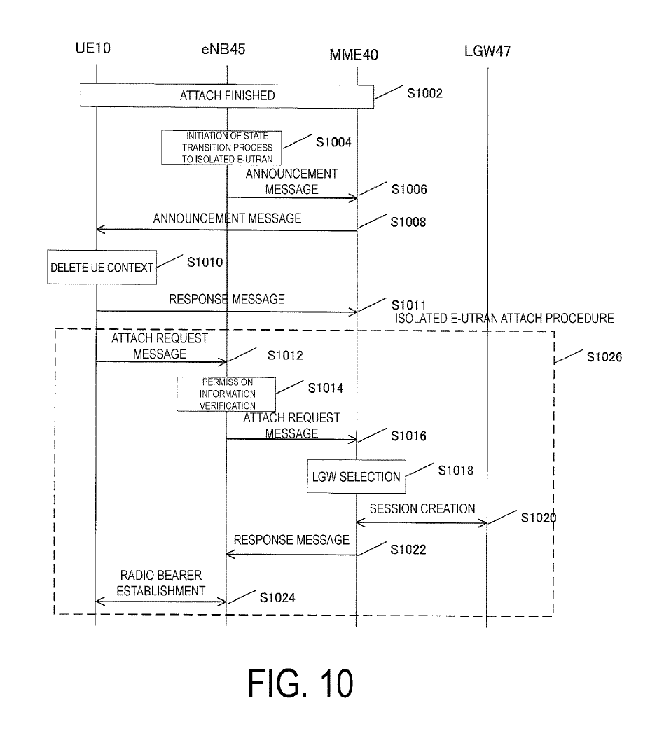

Next, an LTE access network state transition process and a PDN connection switching method will be described, while referring to FIG. 10.

First, the UE 10 is connected to the core network 7 by a conventional attach procedure (S1002). Further, or at the same time, the eNB 45 acquires permission information regarding communication by the UE 10 based on the Isolated E-UTRAN function.

The eNB 45 initiates a state transition process to the Isolated E-UTRAN state B, in which it is necessary to limit communications via the backhaul 2 (S1004).

Note that the initiation trigger for the state transition process may be similar to the trigger for initiating the state transition process to the Isolated E-UTRAN state described in 1.3.1.

Subsequently, the state transition process is described. In the state transition process, the eNB 45 first transmits an announcement message to the MME 40 (S1006). The announcement message transmitted to the MME 40 by the eNB 45 may be a message announcing the connection state to the core network 7 to which the eNB 45 attempts to transition (the Isolated E-UTRAN state B), and/or a message requesting the UE 10 to transmit a detach request message. Notification messages may be messages having at least one of these meanings. Alternatively, these messages may take the form of announcements through individual messages.

The MME 40 receives the announcement message from the eNB 45. The announcement message includes at least identification information of the UE 10, for which communication based on the Isolated E-UTRAN function has been permitted when present within the communication coverage of the eNB 45. The announcement message may further include identification information indicating that the eNB 45 has initiated a procedure to transition to the Isolated E-UTRAN state B.

Separately from the announcement message from the eNB 45 to the MME 40, the eNB 45 may also transmit to the UE 10 broadcast information announcing that a state transition process to the Isolated E-UTRAN state B has been initiated. The broadcast information may include a TFT, or a bearer ID that specifies a bearer for permitting to communicate on the basis of the Isolated E-UTRAN function, or the broadcast information may include identification information about an application for permitting to communicate on the basis of the Isolated E-UTRAN function.

In this case, the eNB 45 has some of the functions of an MME. Specifically, the eNB 45 has the function of storing the UE context.

In response to the receiving of the announcement message, the MME 40 transmits an announcement message to the UE 10 (S1008). The announcement message may be a message requesting the UE 10 to detach, and/or a message requesting the UE 10 to initiate an attach procedure, and/or a message announcing the connection state (the Isolated E-UTRAN state B) to the core network 7 to which the eNB 45 attempts to transition, and/or a message announcing a list of UEs currently present in the communication coverage of the eNB 45. Notification messages may be messages having at least one of these meanings. Alternatively, these messages may take the form of announcements through individual messages.

It should be noted that announcement messages may include an information element identifying the connection state to a core network.

The MME 40 may also include the APN1 in an announcement message transmitted to the UE 10, and announce that a PDN connection which can be re-established is a PDN connection to be established using an APN for which communication based on the Isolated E-UTRAN function is permitted.

Note that the MME 40 may include in the detach request message to the UE 10 a cause value indicating a need for an attachment.

After having transmitted the detach request message, the MME 40 executes a detach procedure within the core network, by transmitting a detach connection request to the SGW 35.

The UE 10 receives the detach request message from the MME 40. The detach request message is a message requesting the UE 10 to initiate a detach and attach procedure. In response to the receiving of the detach request message, the UE 10 deletes the UE context from the storage unit (S1010).

Further, the UE 10 may delete the UE context, in response to the receiving of the detach request message. Further, the UE 10 may transmit to the eNB 45 a response message to the announcement message, in response to the receiving of the detach request message (S1011). The response message is a detach response message, which is a message announcing that detachment has been completed.

The MME 40 receives the detach response message from the UE 10. In response to the receiving of the detach response message, the MME 40 completes the detach procedure.

It should be noted that the MME 40 receives the detach response message from the UE 10 via the eNB 45. That is, the eNB 45 may once receive the detach response message from the UE 10, rather than simply transferring the detach response message.

Further, the eNB 45 may delete the identification information of the UE 10 from the storage unit, on the basis of the detach procedure from the UE 10, and/or receipt of the response message from the UE 10, and/or receipt of a response message. Alternatively, the information may be deleted from the storage unit when having received from the UE 10 an attach request message; or after starting a timer, storing the information until the count of the timer is full.

In this way, the core network state of the eNB 45 may transition to the Isolated E-UTRAN state B, triggered by detachment or by the count of the timer being full.

Alternatively, the eNB 45 may receive a response message from the MME 40, as a response to an announcement message transmitted to the MME 40. Further, the eNB 45 may transition to the Isolated E-UTRAN state B in response to the receiving of the response message. In the process, the MME 40 may include in the transmitted response message identification information indicating to request or announce a transition to the Isolated E-UTRAN state B.

Next, the UE 10 executes an attach procedure, and establishes a PDN connection to communicate on the basis of the Isolated E-UTRAN function (S1026). Here, the attach procedure is expressed as an Isolated E-UTRAN attach procedure, to distinguish it from a conventional attach procedure.

Further, the UE 10 transmits an attach request message to the eNB 45 (S1012). The attach request message may include at least the APN1. Here, the UE 1 need not necessarily transmit the APN by inclusion thereof in the attach request message, and the APN may be transmitted by inclusion in a control message that is transmitted within the attach procedure. The UE 10 may select and transmit the APN1 of a plurality of APNs kept in an APN list, in response to the announcement message transmitted by the eNB 45. More specifically, the UE 10 may select the APN1 because the announcement message indicates that re-establishment using the APN1 is permitted.

When this sort of selection means is unavailable, the UE 10 may announce, to the eNB45, the APN1 and APN2 through an Isolated E-UTRAN attach procedure or a PDN connection establishment procedure.

The eNB 45 receives the attach request message from the UE 10. The attach request message at this time may include the APN1. Alternatively, the APN1 may be included in another control message transmitted to the UE 10 from the eNB 45 included in the attach procedure.

When an APN for which communication based on the Isolated E-UTRAN function is permitted is not stored by the UE 10, the APN1 and APN2 may be included in an attach request message.

In response to the receiving of the APN1 for which communication based on the Isolated E-UTRAN function is permitted, the eNB 45 may verify the permission information provided to the UE 10 (S1014).

Because the state of the LTE access network to which the eNB 45 belongs is the Isolated E-UTRAN state B, the eNB 45 transfers the received attach request message to the MME 40 (S1016).

The MME 40 receives the attach request message from the eNB 45. The MME 40 may perform verification of the permission information, in response to the receiving of the attach request message. Specifically, from the plurality of received APNs, the MME 40 may select the APN1 for which communication based on the Isolated E-UTRAN function has been permitted. Further, the MME 40 may decide whether to permit establishment of a PDN connection on the basis of the APN transmitted by the UE 10. For example, in a case of transitioning to the Isolated E-UTRAN state B, the MME 40 may permit establishment of a PDN connection to an APN permitted to communicate on the basis of the Isolated E-UTRAN function, while rejecting establishment of a PDN connection to an APN not permitted to communicate on the basis of the Isolated E-UTRAN function, and transmitting an attach rejection message to the UE 10.

Alternatively, establishment of a PDN connection to an APN permitted to communicate in the Isolated E-UTRAN state B may be permitted, while rejecting establishment of a PDN connection to an APN permitted to communicate only in the Isolated E-UTRAN state A, and an attach rejection message may be transmitted to the UE 10.

When the MME 40 permits establishment of a PDN connection, the MME 40 may select the LGW 47 as the gateway used for the PDN connection, because the APN1 is an APN for which communication based on the Isolated E-UTRAN function has been permitted (S1018).

The MME 40 creates a session with the selected gateway LGW 47 (S1020). When creating the session, the LGW 47 reassigns an IP address to the UE 10. The MME 40 acquires the IP address of the UE 10 and the TEID of the LGW.

The MME 40 transmits to the eNB 45 a response message to the attach request message (S1022). The attach response message includes at least the IP address of the UE 10 and the TEID of the LGW.

Further, when the MME 40 has selected the APN1 of a plurality of APNs included in the received message from the UE 10, the MME 40 may transmit a response message including the selected APN1 to the eNB 45.

The eNB 45 receives the response message to the attach request message from the MME 40. In response to the receiving of the response message, the eNB 45 initiates a procedure to establish a radio bearer to the UE 10 (S1024). The UE 10 acquires an IP address by the radio bearer establishment procedure.

Further, when the MME 40 has selected the APN1 of a plurality of APNs included in the message received from the UE 10, the eNB 45 may announce, to the UE 10, identification information of the selected APN1 at the time the radio bearer is established.

Further, when a bearer other than the default bearer has been designated as the bearer for use in communication based on the Isolated E-UTRAN function, the eNB 45 may include identification information instructing the UE 10 not to use the default bearer, when the bearer is established. The identification information at this time may be a bearer ID or a TFT identifying a bearer.

Further, when an application for which communication based on the Isolated E-UTRAN has been permitted is designated, when the radio bearer is established, the eNB 45 may announce, to the UE 10, identification information of the application for which communication based on the Isolated E-UTRAN has been permitted.

By so doing, the UE 10 can establish a PDN connection to communicate on the basis of the Isolated E-UTRAN function.

By the above process, the Isolated E-UTRAN attach procedure is completed.

By completing the Isolated E-UTRAN attach procedure, in response to a state transition to the Isolated E-UTRAN state by the eNB 45, the UE 10 can switch a PDN connection that was used for communication in the normal state to a PDN connection for communication based on the Isolated E-UTRAN function, and continue with communication.

Note that the method of communication between UEs present within the communication coverage of the eNB 45 which is included in the access network in the Isolated E-UTRAN state after switching has been completed may be accomplished by the same procedure as in the first embodiment, and a detailed description is omitted.

2.1.2. Method for switching to communication based on Isolated E-UTRAN function: first modification

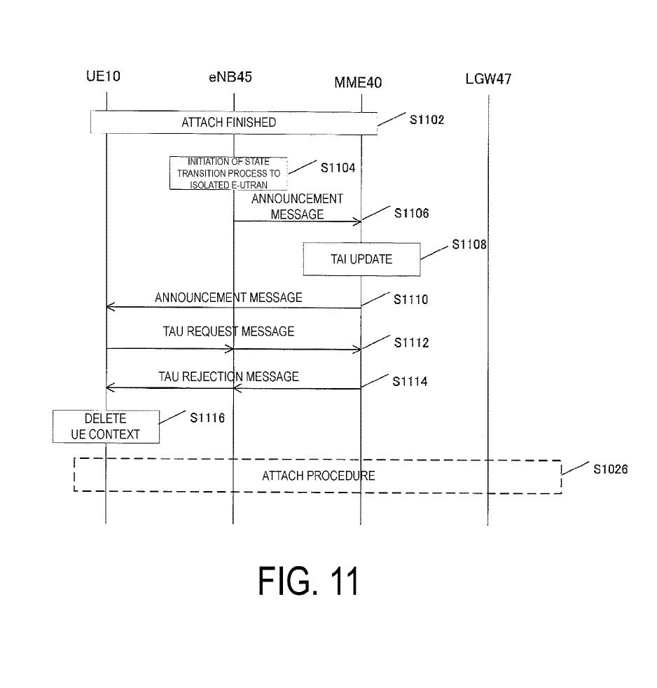

Next, a first modification, which is a communication switching procedure that involves the eNB 45 initiating a state transition to the Isolated E-UTRAN state in order to change the TAI of a UE managed by the MME 40 will be described with reference to FIG. 11.

Note that the initial state of the procedure may be similar to the initial state described in the first embodiment. Therefore, a detailed description of the initial state is omitted.

FIG. 11 is a diagram for illustrating the present modification. First, the UE 10 is connected to the core network 7 by a conventional attach procedure (S1102). Afterwards, or at the same time, the eNB 45 acquires permission information regarding communication by the UE 10 based on the Isolated E-UTRAN function.

The eNB 45 initiates a state transition process to the Isolated E-UTRAN state B, in which it is necessary to limit communications via the backhaul 2 (S1104).

Note that the initiation trigger for the state transition process may be similar to the trigger for initiating the state transition process to the Isolated E-UTRAN state described in 1.3.1.

Next, the state transition process will be described.

First, the eNB 45 transmits an announcement message to the MME 40 (S1106). The announcement message transmitted to the MME 40 by the eNB 45 may be a message announcing a connection state to the core network 7 to which the eNB 45 attempts to transition (the Isolated E-UTRAN state B), and/or a message requesting the UE 10 to transmit a detach request message, and/or a message requesting to update the TAI to a communication-dedicated TAI based on the Isolated E-UTRAN function. Notification messages may be messages having at least one of these meanings. Alternatively, these messages may take the form of announcements through individual messages.

The MME 40 receives the announcement message from the eNB 45. The announcement message includes at least identification information of the UE 10, for which communication based on the Isolated E-UTRAN function has been permitted when present within the communication coverage of the eNB 45. The announcement message may further include identification information indicating that the state of the LTE access network to which the eNB 45 belongs is the Isolated E-UTRAN state B.

Separately from the announcement message from the eNB 45 to the MME 40, the eNB 45 may also transmit to the UE 10 broadcast information announcing that a state transition process to the Isolated E-UTRAN state B has been initiated. The broadcast information may include a TFT, or a bearer ID that specifies a bearer for permitting to communicate on the basis of the Isolated E-UTRAN function, or the broadcast information may include identification information about an application for permitting to communicate on the basis of the Isolated E-UTRAN function.

In this case, the eNB 45 has some of the functions of an MME. Specifically, the eNB 45 has the function of storing the UE context.

The MME 40 may execute a TAI update process in response to the receiving of the announcement message from the eNB 45 (S1108). Specifically, the MME 40 configures the TAI to one different from the TAI that was used in the normal state up to that point in time. It should be noted that the updated TAU may be identification information in which the tracking area code (TAC) included in the TAI has been updated. Further, the TAI newly assigned to the UE 10 may be a special TAI that has been configured because the current state is the Isolated E-UTRAN state. That is, the TAI may be a tracking area ID that indicates an area in which communication based on the Isolated E-UTRAN is performed.

In response to the update of the TAI, the MME 40 transmits an announcement message to the UE 10 (S1110). The announcement message may be a message announcing, to the UE 10, the update of the TAI, and/or a message announcing a connection state to the core network 7 to which the eNB 45 attempts to transition (the Isolated E-UTRAN state B), and/or a layer 2 announcement message requesting release of a radio resource. Notification messages may be messages having at least one of these meanings. Alternatively, these messages may take the form of announcements through individual messages. These messages may also be broadcast information transmitted to the UE 10 by the eNB 45.

When an announcement message is a message announcing an update of the TAI, the MME 40 may include in the announcement message a new TAI assigned to the UE 10.

The UE 10 receives the announcement message from the MME 40, and in response to the receiving of the announcement message, the UE 10 transmits a TAU (Tracking Area Update) request message to the MME 40 via the eNB 45 (S1112).

Specifically, when a new TAI is included in the message received by the UE 10, the UE 10 may verify that no new TAI is included in the TAI list stored by the UE 10, and on the basis of the verification the UE 10 may then transmit a TAU request message to the MME 40.

Alternatively, a message received by the UE 10 may be verified as a message announcing a connection state to the core network 7 to which the eNB 45 attempts to transition, and the UE 10 may then transmit a TAU request message to the MME 40 in response to the received message.

Alternatively, the UE 10 may initiate a TAU procedure in response to the receiving from the MME 40, via the eNB 45, of a layer 2 announcement message requesting release of a radio resource.

Note that the TAU request message may include the updated, new TAI.

The MME 40 receives the TAU request message from the UE 10. The MME 40 performs a TAU request authentication procedure. The eNB 45 may transmit a rejection message in response to the TAU request message (S1114).

Specifically, when a TAI that is different from the TAI newly assigned by the MME 40 is included in a TAU request message received by the MME 40, the eNB 45 can reject the TAU request. Alternatively, because of the state being the Isolated E-UTRAN state, the eNB 45 may reject the TAU request, and delete the UE context that corresponds to the UE 10.

The TAU rejection message may include a value indicating an implicit detach request, and/or a value indicating that UE identification information could not be acquired from the network, by way of a cause value as to why the TAU procedure cannot be performed.

Further, the TAU rejection message may include a message requesting deletion of a Globally Unique Temporary Identifier (GUTI) stored by the UE.

In response to the receiving of the TAU rejection message from the MME 40, the UE 10 deletes the UE context (S1116).

In response to transmission of the TAU rejection method, the MME initiates a timer count, and deletes information relating the UE 10 once the timer count is full, thereby completing implicit detachment.

Further, after completing implicit detachment, the MME 40 may announce, to the eNB 45, the detachment from the UE 10, and the eNB 45 may transition to the Isolated E-UTRAN state.

Alternatively, in response to the receiving of a TAU rejection message addressed to the UE 10, the eNB 45 may initiate a timer count, and perform a state transition to the Isolated E-UTRAN state after the timer count is full. Through the above process, the eNB 45 transitions to the Isolated E-UTRAN state.

Further, the UE 10 initiates an Isolated E-UTRAN attach procedure (S1026).

Note that the Isolated E-UTRAN attach procedure method is similar to that in S1026 of FIG. 10, and therefore a detailed description of the method is omitted.

Through the above process, the procedure for switching to communication based on the Isolated E-UTRAN function can be accomplished through an update of the TAI by the eNB 45.

Note that the method of communication between UEs present within the communication coverage of the eNB 45 which is included in the access network in the Isolated E-UTRAN state after switching has been completed may be accomplished by the same procedure as in the first embodiment, and a detailed description is omitted.

### 2.1.3. Method for Switching to Communication Based on Isolated E-UTRAN Function: Second Modification

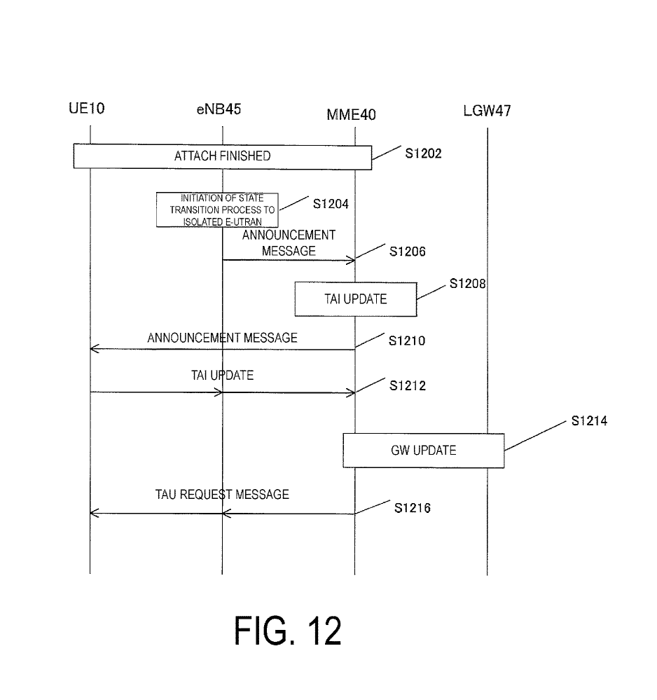

Next, a second modification, which is a communication switching procedure that involves the eNB 45 initiating a state transition to the Isolated E-UTRAN state in order to change the TAI of the UE 10 managed by the MME 40 will be described with reference to FIG. 12. It should be noted that in the present modification, the UE 10 does not require a detach procedure and an attach procedure.

Note that the initial state of the procedure may be similar to the initial state described in the first embodiment. Therefore, a detailed description of the initial state is omitted.

FIG. 12 is a diagram for illustrating the present modification. First, the UE 10 is connected to the core network 7 by a conventional attach procedure (S1202). Further, or at the same time, the eNB 45 acquires permission information regarding communication by the UE 10 based on the Isolated E-UTRAN function.

The eNB 45 initiates a state transition process to the Isolated E-UTRAN state B, in which it is necessary to limit communications via the backhaul 2 (S1204).

Note that the initiation trigger for the state transition process may be similar to the trigger for initiating the state transition process to the Isolated E-UTRAN state described in 1.3.1.

Next, the state transition process will be described.

First, the eNB 45 transmits an announcement message to the MME 40 (S1206). The announcement message transmitted to the MME 40 by the eNB 45 may be a message announcing a connection state to the core network 7 to which the eNB 45 attempts to transition (the Isolated E-UTRAN state B), and/or a message requesting the UE 10 to transmit a detach request message, and/or a message requesting to update the TAI to a communication-dedicated TAI based on the Isolated E-UTRAN function. Notification messages may be messages having at least one of these meanings. Alternatively, these messages may take the form of announcements through individual messages.

The MME 40 receives the announcement message from the eNB 45. The announcement message includes at least identification information of the UE 10, for which communication based on the Isolated E-UTRAN function has been permitted when present within the communication coverage of the eNB 45. The announcement message may further include identification information indicating that the state of the LTE access network to which the eNB 45 belongs is the Isolated E-UTRAN state B.

Separately from the announcement message from the eNB 45 to the MME 40, the eNB 45 may also transmit to the UE 10 broadcast information announcing that a state transition process to the Isolated E-UTRAN state B has been initiated. The broadcast information may include a TFT, or a bearer ID that specifies a bearer for permitting to communicate on the basis of the Isolated E-UTRAN function, or the broadcast information may include identification information about an application for permitting to communicate on the basis of the Isolated E-UTRAN function.

In this case, the eNB 45 has some of the functions of an MME. Specifically, the eNB 45 has the function of storing the UE context.

The MME 40 may execute a TAU update process in response to the receiving of the announcement message from the eNB 45 (S1208). Specifically, the MME 40 configures the TAI to one different from the TAI that was used in the normal state up to that point in time. It should be noted that the updated TAU may be identification information in which the tracking area code (TAC) included in the TAI has been updated. Further, the TAI newly assigned to the UE 10 may be a special TAI that has been configured because the current state is the Isolated E-UTRAN state. That is, the TAI may be a tracking area ID that indicates an area in which communication based on Isolated E-UTRAN is performed.

In response to the update of the TAI, the MME 40 transmits an announcement message to the UE 10 (S1210). The announcement message may be a message announcing, to the UE 10, the update of the TAI, and/or a message announcing the connection state to the core network 7 to which the eNB 45 attempts to transition (the Isolated E-UTRAN state A and/or the Isolated E-UTRAN state B), and/or a layer 2 announcement message requesting release of a radio resource. Notification messages may be messages having at least one of these meanings. Alternatively, these messages may take the form of announcements through individual messages. These messages may also be broadcast information transmitted to the UE 10 by the eNB 45.

When an announcement message is a message announcing an update of the TAI, the MME 40 may include in the announcement message a new TAI assigned to the UE 10.

The UE 10 receives the announcement message from the MME 40, and in response to the receiving of the announcement message, the UE 10 transmits a TAU (Tracking Area Update) request message to the MME 40 via the eNB 45 (S1212).

Specifically, when a new TAI is included in the message received by the UE 10, the UE 10 may verify that no new TAI is included in the TAI list stored by the UE 10, and on the basis of the verification the UE 10 may then transmit a TAU request message to the MME 40.

Alternatively, a message received by the UE 10 may be verified as a message announcing a connection state to the core network 7 to which the eNB 45 attempts to transition, and the UE 10 may then transmit a TAU request message to the MME 40 in response to the received message.

Alternatively, the UE 10 may initiate a TAU procedure on the basis of a case in which the UE 10 is a layer 2 announcement message requesting release of a radio resource, sent from the MME 40 via the eNB 45.

Note that the TAU request message may include the updated, new TAI.

In response to the receiving of the TAU request message, the MME 40 verifies the permission information of the UE 10. When communication based on the Isolated E-UTRAN function is permitted for the UE 10, the MME 40 may change the gateway used for the PDN connection to the LGW 47 (S1214).

Triggered by having changed the gateway used for the PDN connection for carrying out communication based on the Isolated E-UTRAN function, the MME 40 transmits an attach accept message to the UE 10 (S1216).

The attach accept message may include the TEID, IP address, and the like of the selected LGW 47. The UE 10 may also use the received LGW 47 information as identification information of the PDN connection, and as the IP address of the UE. In the process, in association with the change of the gateway, the eNB 45 may assign a new IP address to the UE 10, and announce, to the UE 10, the change of IP address. Alternatively, the eNB 45 may continue to assign the same IP address, without changing the IP address.

Through the above process, the procedure for switching to communication based on the Isolated E-UTRAN function can be accomplished through an update of the TAI by the MME 40. Note that in the present modification, the UE 10 may not transmit an attach request. That is, the UE 10 can continue to communicate without re-establishing a PDN connection. In other words, in the PDN connection that the UE 10 uses to communicate, the PGW serving as the end point of the PDN connection changes from the PGW 30 before the TAU, to the LGE 47 thereafter.

Note that when the IP address is changed on the basis of a TAU, the UE 10 updates the IP address and continues communication. Alternatively, when the IP address has not changed on the basis of a TAU, the UE 10 may perform communication using the same IP address both before and after the TAU.

Note that the method of communication between UEs present within the communication coverage of the eNB 45 which is included in the access network in the Isolated E-UTRAN state after switching has been completed may be accomplished by the same procedure as in the first embodiment, and a detailed description is omitted.

### 3. Third Embodiment

Next, a method for MME-led communication switching when the eNB 45 is included in an LTE access network in the Isolated E-UTRAN state B will be described.

Note that the system overview and device constitution are equivalent to those of the first embodiment, and therefore a detailed description is omitted.

### 3.1. Description of Process

### 3.1.1. Method for Switching to Communication Based on Isolated E-UTRAN Function

Following is a description of an MME-led communication switching method when the state of an LTE access network has transitioned from the E-UTRAN state to the Isolated E-UTRAN state B.

Note that the initial state of the procedure may be similar to the initial state described in the first embodiment. Therefore, a detailed description of the initial state is omitted.

Additionally, in the present embodiment, an APN for which communication based on the Isolated E-UTRAN function is permitted is called APN1, and an APN for which communication based on the Isolated E-UTRAN function is not permitted is called APN2.

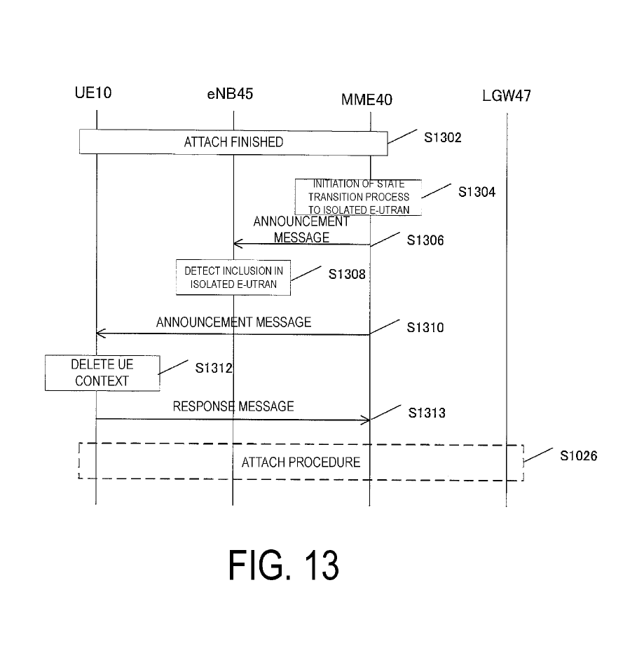

Next, E-UTRAN state transition and a PDN connection switching method will be described, while referring to FIG. 13.

First, the UE 10 is connected to the core network 7 by a conventional attach procedure (S1302). Further, or at the same time, the eNB 45 acquires permission information regarding communication by the UE 10 based on the Isolated E-UTRAN function.

The MME 40 detects a trigger for the base station device eNB 45 managed by the MME 40 to initiate a transition to the Isolated E-UTRAN state B, in which it is necessary to limit communications via the backhaul 2 (S1304).

The Isolated E-UTRAN state B at this time refers to a state in which, for example, due to a disaster or the like the physical connectivity from the eNB 45 to the core network has been partially lost, or the LTE access network to which the eNB belongs has changed due to movement by an eNB that is mobile (a Nomadic eNB), and the LTE access network which is a change destination is in the Isolated E-UTRAN state B.

The initiation trigger for a state transition process may be, for example, detection of a loss of connectivity by the interface (S1-U) between the eNB 45 and the SGW 35, or of a partial loss of connectivity, with the act of detection serving as the trigger.

Alternatively, the initiation trigger for a state transition process may be detection of a loss of connectivity by the interface (S5/S8) between the SGW 35 and the PGE 30, with the act of detection serving as the trigger.

The MME 40 may automatically initiate the state transition process, in association with detection of these triggers.

Alternatively, the MME 40 may be made to initiate the state transition process by a manual operation by the carrier (an administrator of the operator).

In the state transition process, the MME 40 first transmits an announcement message to the eNB 45 (S1306). By transmitting the announcement message, the MME 40 may announce, to the eNB 45 that a state transition to the Isolated E-UTRAN state B has been initiated, and/or announce, to the eNB 45 transmission of an attach request by the UE 10.

By receiving the announcement message from the MME 40, the eNB 45 detects that a transition of the eNB 45 to the Isolated E-UTRAN state B has been initiated (S1308).

Here, in response to the receiving of the announcement message, the eNB 45 may transmit to the UE 10 broadcast information announcing that a state transition process to the Isolated E-UTRAN state B has been initiated. The broadcast information may include a TFT, or a bearer ID that specifies a bearer for permitting to communicate on the basis of the Isolated E-UTRAN function, or the broadcast information may include identification information about an application for permitting to communicate on the basis of the Isolated E-UTRAN function.

In this case, the eNB 45 has some of the functions of an MME. Specifically, the eNB 45 has the function of storing the UE context.

After or at the same time as transmission of the announcement message in S1306, or before transmission of the announcement message, the MME 40 transmits an announcement message to the UE 10 (S1310). The announcement message may be a detach request message requesting the UE 10 to be detached, and/or a message requesting the UE 10 to initiate an attach procedure, and/or a message announcing the connection state to the core network 7 (the Isolated E-UTRAN state B) to which the eNB 45 attempts to transition, and/or a message announcing a list of UEs currently present within the communication coverage of the eNB 45.

Note that announcement messages may include an information element identifying the connection state to a core network.

The MME 40 may also include the APN1 in an announcement message transmitted to the UE 10, and announce that a PDN connection which can be re-established is a PDN connection to be established using an APN for which communication based on the Isolated E-UTRAN function is permitted.

Further, the MME 40 may include in the announcement message to the UE 10 a cause value indicating a need for an attachment.

After transmitting the announcement message to the UE 10, the MME 40 executes a detach procedure within the core network, by transmitting a detach connection request to the SGW 35.

The UE 10 receives the detach request message from the MME 40. The detach request message is a message requesting the UE 10 to initiate a detach and attach procedure, and in response to the receiving of the detach request message, the UE 10 deletes the UE context from the storage unit (S1312).

Further, on the basis of the detach request message, the UE 10 may transmit to the MME 40 a response message to the announcement message (S1313). The response message is a detach response message, which is a message announcing that detachment has been completed.

The MME 40 receives the detach response message from the UE 10. In response to the receiving of the detach response message, the MME 40 completes the detach procedure.

It should be noted that the MME 40 receives the detach response message from the UE 10 via the eNB 45. That is, the eNB 45 may once receive the detach response message from the UE 10, rather than simply transferring the detach response message.

Further, the eNB 45 may delete the identification information of the UE 10 from the storage unit, on the basis of the detach procedure from the UE 10, and/or receipt of the response message from the UE 10, and/or receipt of a response message. Alternatively, the information may be deleted from the storage unit when having received from the UE 10 an attach request message; or after starting a timer, storing the information until the count of the timer is full.

In this way, the core network state of the eNB 45 may transition to the Isolated E-UTRAN state B, triggered by detachment or by the count of the timer being full.

Alternatively, the eNB 45 may receive a response message from the MME 40, as a response to an announcement message transmitted to the MME 40. Further, the eNB 45 may transition to the Isolated E-UTRAN state B in response to the receiving of the response message. In the process, the MME 40 may include in the transmitted response message identification information indicating to request or announce a transition to the Isolated E-UTRAN state B.

After transmitting the response message, the UE 10 performs an attach procedure to the eNB 45 in the Isolated E-UTRAN state (S1026). The attach procedure is similar to the attach procedure illustrated in FIG. 10, and therefore a detailed description is omitted.

By the above process, MME-led service continuity is achieved when the LTE access network has transitioned to the Isolated E-UTRAN state B in which limited access is necessary.

The method of communication between UEs present within the communication coverage of the eNB 45 which is included in the access network in the Isolated E-UTRAN state after switching has been completed may be accomplished by the same procedure as in the first embodiment, and a detailed description is omitted.

### 3.1.2. Method for Switching to Communication Based on Isolated E-UTRAN Function: First Modification

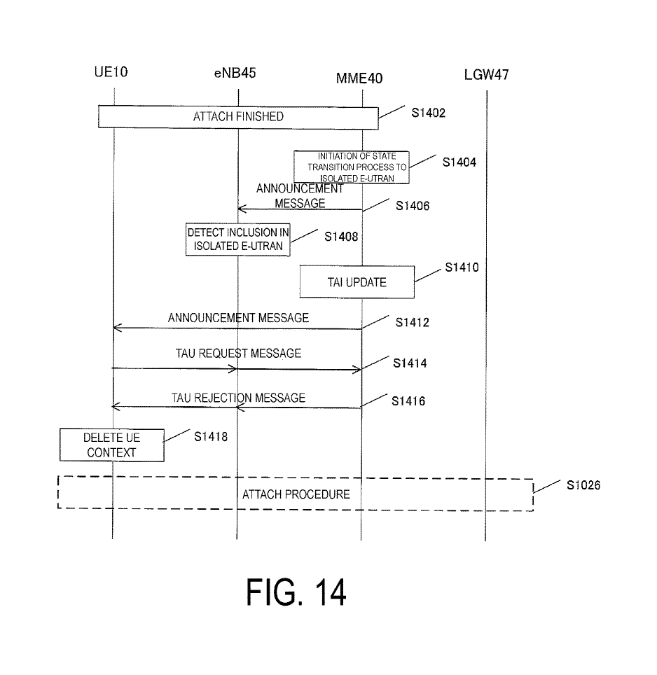

Next, a first modification, which is a communication switching procedure that involves updating the TAI of the UE 10 managed by the MME 40 in association with an MME 40-led transition of the state of the eNB 45 to the Isolated E-UTRAN state will be described with reference to FIG. 14.

The initial state of the procedure may be similar to the initial state described in the first embodiment. Therefore, a detailed description of the initial state is omitted.

FIG. 14 is a diagram for illustrating the present modification. First, the UE 10 is connected to the core network 7 by a conventional attach procedure (S1402). Further, or at the same time, the eNB 45 acquires permission information regarding communication by the UE 10 based on the Isolated E-UTRAN function.

The MME 40 detects a trigger for the base station device eNB 45 managed by the MME 40 to initiate a transition to the Isolated E-UTRAN state B, in which it is necessary to limit communications via the backhaul 2 (S1404).

Note that the initiation trigger for the state transition process may be similar to the trigger for initiating the state transition process to the Isolated E-UTRAN state described in 3.1.1.

Alternatively, using a control signal from the eNB 45 to the MME 40, the MME 40 may also acquire identification information identifying that the eNB 45 has some of the functions of the MME 40, and/or identification information representing capability information indicating the possibility for the eNB 45 to have some of the functions of the MME 40, and/or identification information identifying that the eNB 45 has an Isolated E-UTRAN function. The MME 40 may initiate a transition to the Isolated E-UTRAN state B on the basis of the identification information.

Next, state transition process will be described.

First, the MME 40 transmits an announcement message to the eNB 45 (S1406). The MME 40 may also transmit to the eNB 45 an announcement message, on the basis of identification information identifying that the eNB 45 has some of the functions of the MME 40, and/or identification information representing capability information indicating the possibility for the eNB 45 to have some of the functions of the MME 40, and/or identification information identifying that the eNB 45 has an Isolated E-UTRAN function, which information was acquired from the eNB 45.

By transmitting the announcement message, the MME 40 may announce, to the eNB 45, that a state transition to the Isolated E-UTRAN state B has been initiated, and/or announce, to the eNB 45, transmission of an attach request by the UE 10.

By receiving the announcement message from the MME 40, the eNB 45 detects that transition of the eNB 45 the Isolated E-UTRAN state B has been initiated (S1408).

Here, in response to the receiving of the announcement message, the eNB 45 may transmit to the UE 10 broadcast information announcing that a state transition process to the Isolated E-UTRAN state B has been initiated. The broadcast information may include a TFT, or a bearer ID that specifies a bearer for permitting to communicate on the basis of the Isolated E-UTRAN function, or the broadcast information may include identification information about an application for permitting to communicate on the basis of the Isolated E-UTRAN function.

The eNB 45 may initiate a TAU update process in response to the receiving of the announcement message. Specifically, the eNB 45 configures the TAI to one different from the TAI that was used in the normal state up to that point in time. It should be noted that the updated TAU may be identification information in which the tracking area code (TAC) included in the TAI has been updated. Further, the TAI newly assigned to the UE 10 may be a special TAI that has been configured because the current state is the Isolated E-UTRAN state. That is, the TAI may be a tracking area ID that indicates an area in which communication based on Isolated E-UTRAN is performed. The updated TAI may be included in the transmitted broadcast information.

In this case, the eNB 45 has some of the functions of an MME. Specifically, the eNB 45 has the function of storing the UE context.

On the basis of initiation of a state transition to the Isolated E-UTRAN, the MME 40 initiates a TAU update process (S1410). Specifically, the MME 40 configures the TAI to one different from the TAI that was used in the normal state up to that point in time. It should be noted that the updated TAU may be identification information in which the tracking area code (TAC) included in the TAI has been updated. Further, the TAI newly assigned to the UE 10 may be a special TAI that has been configured because the current state is the Isolated E-UTRAN state. That is, the TAI may be a tracking area ID that indicates an area in which communication based on Isolated E-UTRAN is performed. In response to the update of the TAI, the MME 40 transmits an announcement message to the UE 10 (S1412). The announcement message may be a message announcing, to the UE 10, the update of the TAI, and/or a message announcing a connection state to the core network 7 to which the eNB 45 attempts to transition (the Isolated E-UTRAN state B), and/or a layer 2 announcement message requesting release of a radio resource. Notification messages may be messages having at least one of these meanings. Alternatively, these messages may take the form of announcements through individual messages.

When an announcement message is a message announcing an update of the TAI, the MME 40 may include in the announcement message a new TAI assigned to the UE 10.

The UE 10 receives the announcement message transmitted by the MME 40. In response to broadcast information transmitted by the eNB 45, and/or the announcement message transmitted by the MME, the UE 10 receives the new TAI. In response to the receiving of the new TAI, the receiving of an announcement message from the MME 40, or the receiving of broadcast information from the eNB 45 by the UE 10, the UE 10 transmits a TAU (Tracking Area Update) request message to the MME 40 via the eNB 45 (S1414).

Specifically, when a new TAI is included in the message received by the UE 10, the UE 10 may verify that no new TAI is included in the TAI list stored by the UE 10, and on the basis of the verification the UE 10 may then transmit a TAU request message to the MME 40.

Alternatively, a message received by the UE 10 may be verified as a message announcing a connection state to the core network 7 to which the eNB 45 attempts to transition, and the UE 10 may then transmit a TAU request message to the MME 40 in response to the received message.

Alternatively, the UE 10 may initiate a TAU procedure on the basis of a case in which the UE 10 is a layer 2 announcement message requesting release of a radio resource, sent from the MME 40 via the eNB 45.

Note that the TAU request message may include the updated, new TAI.

The MME 40 receives the TAU request message from the UE 10. The MME 40 performs a TAU request authentication procedure. The eNB 45 may transmit a rejection message in response to the TAU request message (S1416).

Specifically, when a TAI that is different from the TAI newly assigned by the eNB 45 is included in a TAU request message received by the eNB 45, the eNB 45 can reject the TAU request. Alternatively, because of the state being the Isolated E-UTRAN state, the eNB 45 may reject the TAU request, and delete the UE context that corresponds to the UE 10.

The TAU rejection message may include a value indicating an implicit detach request, and/or a value indicating that UE identification information could not be acquired from the network, by way of a cause value as to why the TAU procedure cannot be performed.

Further, the TAU rejection message may include a message requesting deletion of a Globally Unique Temporary Identifier (GUTI) stored by the UE.

In response to transmission of the TAU rejection message by the MME 40, the MME 40 executes a detach procedure within the core network by transmitting a detach connection request to the SGW 35.

In response to the receiving of the TAU rejection message from the MME 40, the UE 10 deletes the UE context (S1418).

It should be noted that, in response to the receiving of the TAU rejection message addressed to the UE 10, the eNB 45 may initiate a timer count, and complete a state transition to the Isolated E-UTRAN state after the timer count is full. Through the above process, the eNB 45 transitions to the Isolated E-UTRAN state.

Further, the UE 10 initiates an Isolated E-UTRAN attach procedure (S1026).

Note that the Isolated E-UTRAN attach procedure method is the same as in S1026 of FIG. 10, and therefore a detailed description of the method is omitted.

Through the above process, the procedure for switching to communication by updating of the TAI by the MME can be accomplished through a state transition process to the Isolated E-UTRAN state, led by the MME 40.

It should be noted that the method of communication between UEs present within the communication coverage of the eNB 45 which is included in the access network in the Isolated E-UTRAN state after the communication switching procedure has been completed may be accomplished by the same procedure as in the first embodiment, and a detailed description is omitted.

### 3.1.3. Method for Switching to Communication Based on Isolated E-UTRAN Function: Second Modification

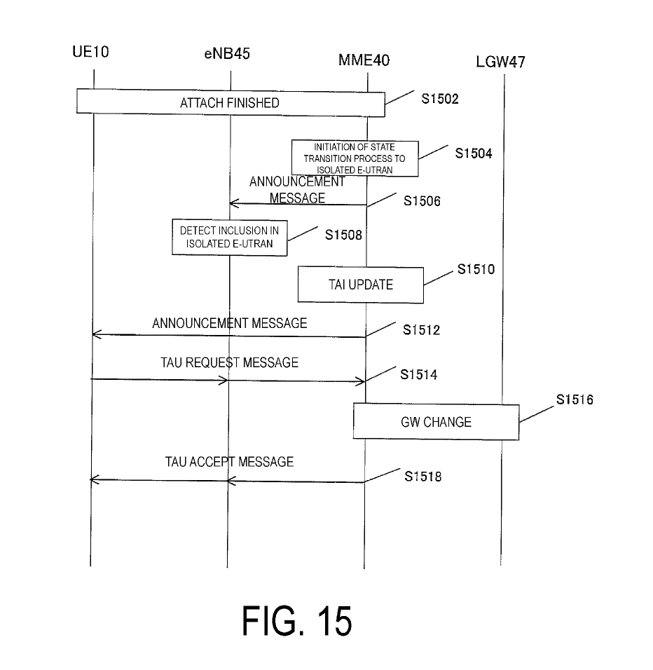

Next, a second modification, which is a communication switching procedure that involves updating the TAI of the UE 10 managed by the MME 40 in an MME 40-led state transition to the Isolated E-UTRAN state will be described with reference to FIG. 15.

Note that the initial state of the procedure may be similar to the initial state described in the first embodiment. Therefore, a detailed description of the initial state is omitted. FIG. 15 is a diagram for illustrating the present modification. First, the UE 10 is connected to the core network 7 by a conventional attach procedure (S1502). Further, or at the same time, the eNB 45 acquires permission information regarding communication by the UE 10 based on the Isolated E-UTRAN function.

The MME 40 detects a trigger for the base station device eNB 45 managed by the MME 40 to initiate a transition to the Isolated E-UTRAN state B, in which it is necessary to limit communications via the backhaul 2 (S1504).

Note that the initiation trigger for the state transition process may be similar to the trigger for initiating the state transition process to the Isolated E-UTRAN state described in 1.3.1.

Using a control signal from the eNB 45 to the MME 40, the MME 40 may also acquire identification information identifying that the eNB 45 has some of the functions of the MME 40, and/or identification information representing capability information indicating the possibility for the eNB 45 to have some of the functions of the MME 40, and/or identification information identifying that the eNB 45 has an Isolated E-UTRAN function. The MME 40 may initiate a transition to the Isolated E-UTRAN state B on the basis of the identification information.

Next, the state transition process will be described.

First, the MME 40 transmits an announcement message to the eNB 45 (S1506). The MME 40 may also transmit to the eNB 45 an announcement message, on the basis of identification information identifying that the eNB 45 has some of the functions of the MME 40, and/or identification information representing capability information indicating the possibility for the eNB 45 to have some of the functions of the MME 40, and/or identification information identifying that the eNB 45 has an Isolated E-UTRAN function, which information was acquired from the eNB 45.

The announcement message includes at least the identification information of the UE 10, and by transmitting the announcement message, the MME 40 may announce, to the eNB 45, that a state transition to the Isolated E-UTRAN state has been initiated.

Further, the MME 40 may announce, to the eNB 45, transmission of an attach request by the UE 10.

By receiving the announcement message from the MME 40, the eNB 45 detects that a transition of the eNB 45 to the Isolated E-UTRAN state B has been initiated (S1508).

Here, in response to the receiving of the announcement message, the eNB 45 may transmit to the UE 10 broadcast information announcing that a state transition process to the Isolated E-UTRAN state B has been initiated. The broadcast information may include a TFT, or a bearer ID that specifies a bearer for permitting to communicate on the basis of the Isolated E-UTRAN function, or the broadcast information may include identification information about an application for permitting to communicate on the basis of the Isolated E-UTRAN function.

The eNB 45 may initiate a TAU update process in response to the receiving of the announcement message. Specifically, the eNB 45 configures the TAI to one different from the TAI that was used in the normal state up to that point in time. It should be noted that the updated TAU may be identification information in which the tracking area code (TAC) included in the TAI has been updated. Further, the TAI newly assigned to the UE 10 may be a special TAI that has been configured because the current state is the Isolated E-UTRAN state. That is, the TAI may be a tracking area ID that indicates an area in which communication based on Isolated E-UTRAN is performed. Further, the updated TAI may be included in the transmitted broadcast information.

In this case, the eNB 45 has some of the functions of an MME. Specifically, the eNB 45 has the function of storing the UE context.

On the basis of initiation of a state transition to the Isolated E-UTRAN, the MME 40 initiates a TAU update process (S1510). Specifically, the MME 40 configures the TAI to one different from the TAI that was used in the normal state up to that point in time. It should be noted that the updated TAU may be identification information in which the tracking area code (TAC) included in the TAI has been updated. Further, the TAI newly assigned to the UE 10 may be a special TAI that has been configured because the current state is the Isolated E-UTRAN state. That is, the TAI may be a tracking area ID that indicates an area in which communication based on Isolated E-UTRAN is performed.

In response to the update of the TAI, the MME 40 transmits an announcement message to the UE 10 (S1512). The announcement message may be a message announcing, to the UE 10, the update of the TAI, and/or a message announcing the connection state to the core network 7 to which the eNB 45 attempts to transition (the Isolated E-UTRAN state A and/or the Isolated E-UTRAN state B), and/or a layer 2 announcement message requesting release of a radio resource. Notification messages may be messages having at least one of these meanings. Alternatively, these messages may take the form of announcements through individual messages. These messages may also be broadcast information transmitted to the UE 10 by the eNB 45.

The UE 10 receives the announcement message transmitted by the MME 40. In response to broadcast information transmitted by the eNB 45, and/or the announcement message transmitted by the MME, the UE 10 receives the new TAI. In response to the receiving of the new TAI, the receiving of an announcement message from the MME 40, or the receiving of broadcast information from the eNB 45 by the UE 10, the UE 10 transmits a TAU (Tracking Area Update) request message to the MME 40 via the eNB 45 (S1514).

Specifically, when a new TAI is included in the message received by the UE 10, the UE 10 may verify that no new TAI is included in the TAI list stored by the UE 10, and on the basis of the verification the UE 10 may then transmit a TAU request message to the MME 40.

Alternatively, a message received by the UE 10 may be verified as a message announcing a connection state to the core network 7 to which the eNB 45 attempts to transition, and the UE 10 may then transmit a TAU request message to the MME 40 in response to the received message.

Alternatively, the UE 10 may initiate a TAU procedure on the basis of a case in which the message to the UE 10 is a layer 2 announcement message requesting release of a radio resource, sent from the MME 40 via the eNB 45.

Note that the TAU request message may include the updated, new TAI.

In response to the receiving of the TAU request message, the MME 40 verifies the permission information of the UE 10. When communication based on the Isolated E-UTRAN function is permitted for the UE 10, the MME 40 may change the gateway used for the PDN connection to the LGW 47 (S1516).

Triggered by having changed the gateway used for the PDN connection configured to perform communication based on the Isolated E-UTRAN function, the MME 40 transmits an attach accept message to the UE 10 (S1518).

The attach accept message may include the TEID, IP address, and the like of the selected LGW 47. The UE 10 may also use the received LGW 47 information as identification information of the PDN connection, and as the IP address of the UE. In the process, in association with the change of the gateway, the eNB 45 may assign a new IP address to the UE 10, and announce, to the UE 10, the change of IP address. Alternatively, the eNB 45 may continue to assign the same IP address, without changing the IP address.

Through the above process, the procedure for switching to communication based on the Isolated E-UTRAN function can be accomplished through an update of the TAI by the MME 40. In the present modification, the UE 10 may not transmit an attach request. That is, the UE 10 can continue to communicate without re-establishing a PDN connection. In other words, in the PDN connection that the UE 10 uses to communicate, the PGW serving as the end point of the PDN connection changes from the PGW 30 before the TAU, to the LGE 47 thereafter.

Note that when the IP address is changed on the basis of a TAU, the UE 10 updates the IP address and continues communication. Alternatively, when the IP address has not changed on the basis of a TAU, communication may be performed using the same IP address both before and after the TAU.

Note that the method of communication between UEs present within the communication coverage of the eNB 45 which is included in the access network in the Isolated E-UTRAN state after switching has been completed may be accomplished by the same procedure as in the first embodiment, and a detailed description is omitted.

### 4. Modification Example

Additionally, the program running on each of the devices in each of the embodiments are programs that control a CPU or the like (programs that cause a computer to function) so as to realize the functions in the above-described embodiments. The information handled by these devices is temporarily accumulated in a transitory storage device (RAM, for example) at the time of processing, and is then stored in various storage devices such as a ROM and an HDD, read out by the CPU as necessary, and edited and written.

Here, recording media for storing the programs may be a semiconductor medium (a ROM, a non-volatile memory card, or the like, for example), an optical recording medium/magneto-optical recording medium (a digital versatile disc (DVD), a magneto optical disc (MO), a mini disc (MD), a compact disc (CD), a BD, or the like, for example), a magnetic recording medium (magnetic tape, a flexible disk, or the like, for example), and the like. In addition to implementing the functions of the above-described embodiments by executing programs that have been loaded, there are also cases where the functions according to an aspect of the present invention are implemented by the programs running cooperatively with an operating system, other application programs, or the like on the basis of instructions included in those programs.

For distribution to the market, programs can be distributed in the form of storage in a portable recording medium, or can be transferred to a server computer connected via a network such as the Internet. In this case, the storage device of the server computer would of course be included in the present invention as well.

Additionally, each device in the above-described embodiment may be partially or completely implemented as a large scale integration (LSI) circuit, which is typically an integrated circuit. The functional blocks of each device may be individually implemented as chips, or may be partially or completely integrated into a chip. The circuit integration technique is not limited to LSI, and the integrated circuits for the functional blocks may be implemented as application specific integrated circuits or a general-purpose processor. Furthermore, if advances in semiconductor technology produce circuit integration technology capable of taking over LSI, it is of course possible to use integrated circuits based on the technology.

Additionally, although the above-described embodiment described LTE and a WLAN (IEEE 802.11a/b/n, for example) as examples of radio access networks, the connections may be made with WiMAX instead of a WLAN.

### REFERENCE SIGNS LIST

1 Communication system

2 Backhaul

7 Core network

9 PDN

10 UE

20 UE

30 PGW

35 SGW

40 MME

45 eNB

47 LGW

50 HSS

55 AAA

60 PCRF

65 ePDG

70 WLAN ANa

75 WLAN ANb

80 LTE AN

1. A base station device configured to:
establish a first PDN connection to a first terminal device;
establish a second PDN connection to a second terminal device,
the first PDN connection and the second PDN connection being PDN connections established using an APN for which communication based on an Isolated E-UTRAN function has been permitted, and
the Isolated E-UTRAN function being a user data transfer function by a base station device in a first state in which the base station device lacks connectivity to a core network and/or a second state in which connectivity of the base station device to the core network is limited;
use the first PDN connection to receive user data transmitted by the first terminal device; and
use the second PDN connection to transmit the user data to the second terminal device.

2. A base station device configure to:
acquire an access point name (APN) included in a control message of an attach procedure initiated by a first terminal device,
the APN being an APN for which communication based on an Isolated E-UTRAN function has been permitted, and
the Isolated E-UTRAN function being a user data transfer function by a gateway in a first state in which the base station device lacks connectivity to a core network and/or a second state in which connectivity of the base station device to the core network is limited;
select, in response to the acquiring of the APN, a first gateway the use of which as a gateway for providing a PDN connection in the Isolated E-UTRAN function is permitted; and
permit a first PDN connection to be established between the first gateway and the first terminal device.

3. The base station device according to claim 1, further configured to: acquire, on the basis of the first terminal device being connected to the core network by using the APN for which communication based on the Isolated E-UTRAN function has been permitted, first permission information for permitting to communicate on the basis of the Isolated E-UTRAN function from a first position management device or the first terminal device,
the first position management device being a device configured to perform position management of the first terminal device; and
store the first PDN connection and the first permission information associated therewith.

4. The base station device according to claim 1, further configured to: transmit a first announcement message to the first terminal device,
the first announcement message being a message announcing a detach request, and a need for an attachment; and
acquire the APN by an attach procedure initiated by the first terminal device in response to the first announcement message.

5. The base station device according to claim 4,
wherein the first announcement message is a layer 2 level message, and
the first announcement message requests deletion of a terminal context stored by the first terminal device and indicating an attach state of the first terminal device.

6. The base station device according to claim 1, further configured to: broadcast, to a radio area of the base station, first tracking area identification information which is included in broadcast information, in order to receive a tracking area update request message from the first terminal device, in response to a transition to the first state and/or the second state,
the first tracking area identification information being identification information that differs from second tracking area identification information which has been included in broadcast information transmitted prior to transition to the first state and/or the second state; and
receive a tracking area update request message from the first terminal device.

7. A terminal device configured to:
establish a PDN connection using an access point name (APN) for which communication based on an Isolated E-UTRAN function has been permitted,
the Isolated E-UTRAN function being a user data transfer function by a base station device or a gateway in a first state in which the base station device lacks connectivity to a core network and/or a second state in which connectivity of the base station device to the core network is limited, and
the PDN connection being a PDN connection for which communication based on the Isolated E-UTRAN function has been permitted; and
use the PDN connection to transmit the user data to the base station device.

8. The terminal device according to claim 7, further configured to transmit, on the basis of the APN the PDN connection having been established by using the APN, by the terminal device, permission information for permitting to communicate on the basis of an Isolated E-UTRAN function to the base station device.

9. The terminal device according to claim 8, further configured to: receive an announcement message from the base station device,
the announcement message being a message announcing a detach request and a need for an attachment; and
transmit, in response to the receiving of the announcement message, to the base station device, an attach request message to initiate an attach procedure.

10. The terminal device according to claim 9, wherein the announcement message is a layer 2 level message, and the terminal device is further configured to delete, in response to the receiving of the announcement message, from the terminal device, a terminal context indicating an attach state of the terminal device.

11. The terminal device according to claim 10, wherein the announcement message includes identification information that identifies an application, and the terminal device is further configured to: release a radio resource that was allocated to the application, in response to the receiving of the announcement message; and
transmit, to the base station device, a response message to the announcement message.

12. The terminal device according to claim 7, further configured to: receive broadcast information broadcast by the base station device and/or a position management device,
the broadcast information including first tracking area identification information,
the position management device being a device configured to perform position management of the terminal device, and
the first tracking area identification information being identification information that differs from second tracking area identification information which has been included in broadcast information transmitted prior to transition to the first state and/or the second state; and
transmit, in response to the receiving of the broadcast information, a tracking area update request message to the base station device.

13. A method of controlling a base station device, comprising:
establishing a first PDN connection to a first terminal device;
establishing a second PDN connection to a second terminal device,
the first PDN connection and the second PDN connection being PDN connections established using an APN for which communication based on an Isolated E-UTRAN function has been permitted, and
the Isolated E-UTRAN function being a user data transfer function employed by the base station device in a first state in which the base station device lacks connectivity to a core network and/or a second state in which connectivity of the base station device to the core network is limited;
using the first PDN connection to receive user data transmitted by the first terminal device; and
using the second PDN connection to transmit the user data to the second terminal device.

14. A method of controlling a base station device, comprising
acquiring an access point name (APN) included in a control message of an attach procedure initiated by a first terminal device,
the APN being an APN for which communication based on an Isolated E-UTRAN function has been permitted, and
the Isolated E-UTRAN function being a user data transfer function by a gateway in a first state in which the base station device lacks connectivity to a core network and/or a second state in which connectivity of the base station device to the core network is limited;
selecting, in response to the acquiring of the APN, a first gateway the use of which as a gateway for providing a PDN connection in the Isolated E-UTRAN function is permitted; and
permitting a first PDN connection to be established between the first gateway and the first terminal device.

15. The method of controlling a base station device according to claim 13, further comprising the:
acquiring, on the basis of the first terminal device being connected to the core network by using the APN for which communication based on the Isolated E-UTRAN function has been permitted, first permission information for permitting to communicate on the basis of the Isolated E-UTRAN function from a first position management device or the first terminal device,
the first position management device being a device configured to perform position management of the first terminal device; and
storing the first PDN connection and the first permission information in association therewith.

16. The method of controlling a base station device according to claim 13, further comprising:
transmitting a first announcement message to the first terminal device,
the first announcement message being a message announcing a detach request and a need for an attachment; and
acquiring the APN by an attach procedure initiated by the first
terminal device in response to the first announcement message.

17. The method of controlling a base station device according claims 16, wherein
the first announcement message is a layer 2 level message, and
the method further comprises requesting, by the first announcement message, deletion of a terminal context stored by the first terminal device and indicating an attach state of the first terminal device.

18. The method of controlling a base station device according claim 13, further comprising:
broadcasting, to a radio area of the base station device, first tracking area identification information which is included in broadcast information, fin order to receive a tracking area update request message from the first terminal device, in response to a transition to the first state and/or the second state,
the first tracking area identification information being identification information that differs from second tracking area identification information which has been included in the broadcast information transmitted prior to transition to the first state and/or the second state; and
receiving a tracking area update request message from the first terminal device.

19. A method of controlling a terminal device, comprising:
establishing a PDN connection using an access point name (APN) for which communication based on an Isolated E-UTRAN function has been permitted,
the Isolated E-UTRAN function being a user data transfer function by a base station device or a gateway in a first state in which the base station device lacks connectivity to a core network and/or a second state in which connectivity of the base station device to the core network is limited, and
the PDN connection being a PDN connection for which communication based on the Isolated E-UTRAN function has been permitted; and
using the PDN connection to transmit the user data to the base station device.

20. The method of controlling a terminal device according to claim 19, further comprising: transmitting, on the basis of the PDN connection having been established by using the APN, by the terminal device, permission information for permitting to communicate on the basis of an Isolated E-UTRAN function to the base station device.

21. The method of controlling a terminal device according to claim 20, further comprising:
receiving an announcement message from the base station device,
the announcement message being a message announcing a detach request and a need for an attachment; and
transmitting, in response to the receiving of the announcement message, an attach request message to the base station device to initiate an attach procedure.

22. The method of controlling a terminal device according to claim 21, wherein the announcement message is a layer 2 level message, and
the method further comprises: deleting, in response to the receiving of the announcement message, from the terminal device, a terminal context indicating an attach state of the terminal device.

23. The method of controlling a terminal device according to claim 22, wherein the announcement message includes identification information that identifies an application, and the method further comprises:
releasing a radio resource that was allocated to the application, in response to the receiving of the announcement message h; and
transmitting, to the base station device, a response message to the announcement message.

24. The method of controlling a terminal device according to claim 19, further comprising:
receiving broadcast information broadcast by the base station device and/or a position management device, wherein
the position management device is a device configured to perform position management of the terminal device, and
the broadcast information includes first tracking area identification information,
the first tracking area identification information is identification information that differs from second tracking area identification information which has been included in broadcast information transmitted prior to transition to the first state and/or the second state, and
transmitting, in response to the receiving of the broadcast information, a tracking area update request message to the base station device.

25. The base station device according to claim 2, further configured to: acquire, on the basis of the first terminal device being connected to the core network by using the APN for which communication based on the Isolated E-UTRAN function has been permitted, first permission information for permitting to communicate on the basis of the Isolated E-UTRAN function from a first position management device or the first terminal device,
the first position management device being a device configured to perform position management of the first terminal device; and
store the first PDN connection and the first permission information associated therewith.

26. The base station device according to claim 2, further configured to: transmit a first announcement message to the first terminal device,
the first announcement message being a message announcing a detach request, and a need for an attachment; and
acquire the APN by an attach procedure initiated by the first terminal device in response to the first announcement message.

27. The base station device according to claim 26,
wherein the first announcement message is a layer 2 level message, and
the first announcement message requests deletion of a terminal context stored by the first terminal device and indicating an attach state of the first terminal device.

28. The base station device according to claim 2, further configured to: broadcast, to a radio area of the base station, first tracking area identification information which is included in broadcast information, in order to receive a tracking area update request message from the first terminal device, in response to a transition to the first state and/or the second state,
the first tracking area identification information being identification information that differs from second tracking area identification information which has been included in broadcast information transmitted prior to transition to the first state and/or the second state; and
receive a tracking area update request message from the first terminal device.

29. The method of controlling a base station device according to claim 14, further comprising the:
acquiring, on the basis of the first terminal device being connected to the core network by using the APN for which communication based on the Isolated E-UTRAN function has been permitted, first permission information for permitting to communicate on the basis of the Isolated E-UTRAN function from a first position management device or the first terminal device,
the first position management device being a device configured to perform position management of the first terminal device; and
storing the first PDN connection and the first permission information in association therewith.

30. The method of controlling a base station device according to claim 14, further comprising:
transmitting a first announcement message to the first terminal device,
the first announcement message being a message announcing a detach request and a need for an attachment; and
acquiring the APN by an attach procedure initiated by the first
terminal device in response to the first announcement message.

31. The method of controlling a base station device according claim 30, wherein
the first announcement message is a layer 2 level message, and
the method further comprises requesting, by the first announcement message, deletion of a terminal context stored by the first terminal device and indicating an attach state of the first terminal device.

32. The method of controlling a base station device according claim 14, further comprising:
broadcasting, to a radio area of the base station device, first tracking area identification information which is included in broadcast information, fin order to receive a tracking area update request message from the first terminal device, in response to a transition to the first state and/or the second state,
the first tracking area identification information being identification information that differs from second tracking area identification information which has been included in the broadcast information transmitted prior to transition to the first state and/or the second state; and
receiving a tracking area update request message from the first terminal device.
